(19) United States
(12) Patent Application Publication
(10) Pub. No.: US 2026/0200147 A1
(43) Pub. Date: Jul. 16, 2026

(54) GEOMETRY OF POLYMERIC ROOF SHINGLES

(71) Applicant: Precision Materials Group Holdings, LLC, Lake Mary, FL (US)

(72) Inventors: Scott Stickler, Belle Isle, FL (US); Charles Morton Gould, Winter Springs, FL (US)

(21) Appl. No.: 19/543,069

(22) Filed: Feb. 18, 2026

Related U.S. Application Data
(63) Continuation-in-part of application No. 18/915,617, filed on Oct. 15, 2024.

(51) Int. Cl. B29C 45/14; B29C 45/00; B29L 31/10; E04D 1/00; E04D 1/20

(52) U.S. Cl. CPC B29C 45/14631; B29C 45/0055; E04D 1/20; B29K 2995/0072; B29K 2995/0097; B29L 2031/108; E04D 2001/005

(57) ABSTRACT

Roof shingles and methods of production thereof are provided. The roofing tiles or shingles may feature a unique surface texture and relief, obtained through the use of granules of varying sizes and a preferably multi-tiered substrate. The disclosure further encompasses methods of manufacturing such tiles, preferably including the use of molding techniques to combine different materials for enhanced performance and aesthetic effects. The disclosure also defines parameters for fixing surface texture, granule size, and material selection, and describes various manufacturing processes for creating a desired surface geometry and texture.

### CROSS-REFERENCE TO RELATED APPLICATIONS

This application is a continuation-in-part of currently-pending, commonly-assigned, U.S. patent application Ser. No. 18/932,809, the entire disclosure of which is hereby incorporated herein by reference in its entirety. The present application builds upon the subject matter disclosed in the parent application by providing additional embodiments, features, and methods related to the geometry, material selection, and manufacturing processes for roofing tiles or shingles with enhanced material selection, enhanced surface textures and relief. The improvements and new aspects described herein are directed to further optimizing the performance, aesthetics, and manufacturability of such roofing products, while maintaining compatibility with the foundational concepts and claims set forth in the priority application.

### FIELD OF TECHNOLOGY

Aspects of the disclosure relate to geometry of roofing materials. In particular, the disclosure relates to geometry of polymeric roof shingles.

### BACKGROUND OF THE DISCLOSURE

For decades, use of asphalt shingles has been widespread in the roofing industry. In the U.S., asphalt shingles were introduced in the early 20^{th} Century. Since then, asphalt shingles have been improved and diversified. Improvements include surface-impregnation with crushed rock granules to add heft (for resistance against impact and against wind-uplift) and to provide traction (for roofer-safety). Diversification has yielded the standard “3-tab” panel and laminated “architectural” asphalt shingles. Those two asphalt tile types were used in ~75% of the five million U.S. roofing jobs of 2023.

That ~25% of U.S. roofing jobs do not currently make use of asphalt shingles points to drawbacks associated with their use, mostly dealing with material durability. Roofs necessarily being exposed to sunshine, the relatively weak resistance of asphalt to degradation by ultra-violet (“UV”) radiation represents a serious deficit. UV absorption by the asphalt leads over the years to brittleness and, eventually, to failure of shingle material.

Roofs also absorb sunshine's infra-red (“IR”) radiation. IR heating may lead to daytime roof temperatures running ~10°-~25° C. (~50°-~75° F.) higher than ambient air temperatures. That heat may blister asphalt, leading to cracked shingles and, consequently, leaking. Similar damage can come from other heat sources, such as embers from wildfires and even from backyard firepits, igniting burns in the flammable asphalt.

Shingles typically overlie and are nailed to a wood roof. Nails are driven through an upslope “conceal” section of the shingle, so termed because that nail-bearing section is then covered and concealed by a “reveal” section of an adjacent and overlapping upslope shingle. The reveal typically remains uncovered.

The upslope shingle's reveal covers and protects the nail-hole-bearing conceal of the downslope shingle. Usually, in roofing with multi-tab shingle panels, tab alignments are alternated horizontally (i.e., approximately parallel to the plane of the roof) with each course of shingles, with every other course's shingle's tabs vertically aligned. Besides lending the roof a now-traditional aesthetic appeal, such alternation provides additional water-protection by precluding continuous down-streaming along aligned inter-tab spaces.

Nails, wood and asphalt have significantly different coefficients of expansion. Thus, daytime heating and precipitous cooling of the roof, as often accompany summer thunderstorms, may shift shingles' positions relative to each other and relative to the underlying wood, leaving gaps that lead to leaks. Such shifting may occur, but usually on a slower accumulating basis, due to everyday diurnal thermocycling.

Shifting of shingles parallel to and/or away from the plane of the roof substrate upon which they lie may also contribute to susceptibility of the shingles to wind-uplift and dislodgement. This was seen in the wake of Hurricane Ian's destructive surge through Florida in 2022. Asphalt tiles with claimed ratings of resistance to uplift at winds of up to 130 miles per hour (“mph”) experienced catastrophic failure, even in locales that saw diminished Ian inland windspeeds of ~90 mph.

The above deficits of asphalt shingles translate into a limited useful lifetime of 10-20 years for the typical asphalt shingle roof under regular weathering and aging conditions. The lifetime can be extended, under good conditions and with maintenance, to perhaps 25 years. Conversely, severe weathering and aging conditions tend to shorten the lifetime. For instance, many of the wind-uplift failures associated even with Ian's diminished windspeeds of ~90 mph were suffered by roofs notably younger than 10 years. Given asphalt shingle roofs' realistic lifetime limits, insurance companies may “age gate” a typical asphalt shingle roof starting at 15 years and may drop home insurance coverage at that point.

After an asphalt shingle roof's 10-20 year lifetime (or after the roof has sustained irreparable damage, as from hurricanes, wildfires, hailstorms, etc.) and needs to be replaced, there comes into play a further drawback of asphalt shingles associated with their material durability; viz., their being practically nonrecyclable. Asphalt shingles may require several centuries to decompose in landfills, the sites in which most discarded asphalt shingles are disposed.

Estimates of U.S. landfill dumping of asphalt shingles range up to 10 million tons added annually, with over 80% coming from roof removal from existing houses. The bulkiness and incompressibility of the asphalt shingles require ever increasing and capacious landfill sites. Many such sites are not equipped with barriers for containing potentially carcinogenic compounds that leech from the decomposing petroleum-based asphalt. Even sites built with such containment measures have not proven to adequately protect adjacent aquifers, rivers and soil.

As an alternative to asphalt shingles, sheet metal panels made a mid-to-late 20^{th} century return to popularity in the U.S., but have not achieved the widespread use they enjoyed in the 19^{th} century. Even with metal (such as steel) roofing materials' longer lifetimes (~20-~50 years); better resistance against effects of solar radiation, hurricanes, wildfires, hailstorms, etc.; and high recyclability, all as compared to asphalt shingles, sheet metal roofing currently has only ~10% U.S. market share. Such improvements as using advanced galvanized steel, stone-pressed and corrugated panels, and acrylic overglazing do not seem to have garnered more of the U.S. market share for metal roofing. Some of the reasons for the slow growth of metal roofing popularity are thought to include a sharper rise in metal roofing materials costs over asphalt materials costs; lower plasticity (e.g., incomplete return to flatness after being bent); and higher installation complexity, roofer-safety concerns and labor costs associated with metal roofing materials.

Dupont's 1950s production of weather-resistant rubber-sheet membranes of polymerized ethylene-propylene-diene monomer (“EPDM”) provided the roofing industry a material never before available. EPDM is both durable and easily handled in installation, maintenance and post-lifetime recyclability. The polymer's single bonds between its constituent polymethylene monomers lend EPDM resistance to UV radiation that asphalt's substantial number of UV-vulnerable π bonds cannot rival. Similarly, EPDM is highly resistant to chemical oxidation. The dienes of the three-monomer polymer (“terpolymer”) are selected to facilitate “vulcanization” reaction-induced cross-linking between multiple linear terpolymer chains, to yield “two-dimensional” networked sheeting of various thicknesses.

EPDM is currently used in a variety of roofing applications. EPDM sheeting is often colored (e.g., black by addition of carbon black; white, by calcium carbonate) and/or surface-impregnated with EPDM granules to achieve the appearance of historically more traditional roofing material.

Current EPDM roofing applications include, notably, flat-roof applications (for, e.g., commercial, industrial, multi-apartment residential buildings). Flat-roof applications have benefited from EPDM's ease of installation and maintenance over such alternatives as bitumen and tar paper, and from EPDM's notable weathering/wear properties.

Usually handled in installations as rolls or sheets, EPDM has also been used successfully in low-slope applications, where roof pitch is below 9.5° from the horizontal (a maximum of approximately one foot of roof rise per six feet of horizontal run).

EPDM membranes are usually affixed to roof surfaces by adhesive and/or specialized clips. Nailing is not a standard affixment option, because nail holes could provide entry to precipitation, and could also provide stress-failure points for further membrane ripping/tearing.

Given the limitations on its affixment, EPDM rolls/sheets are not used in steep-slope applications of roof pitch 9.5° or higher. EPDM roll/sheet material cannot successfully be affixed to or may not remain affixed to a steep-slope roof, failing catastrophically under storm conditions notably less severe than hurricanes.

It would be desirable, therefore, to provide EPDM roofing material operable for use on both low-slope roofs and steep-slope roofs, even under severe weathering/wear conditions.

It would be further desirable to provide EPDM roofing materials that exhibit the structural integrity, high recyclability and long lifetime of metal roofing materials together with the familiar shape/look and ease-of-installation of asphalt shingles, the latter factor inclusive of accommodating nail-affixment and also providing roofer-safety.

### SUMMARY OF THE DISCLOSURE

The disclosure provides roofing tiles and materials operable for use on steep-slope roofs, even under severe weathering/wear conditions. The roofing tiles and materials provided may include EPDM roofing shingles.

The roofing tiles may exhibit the structural integrity, high recyclability and long lifetime of metal roofing materials together with the familiar shape/look and ease-of-installation of asphalt shingles, well accommodating nail-affixment and providing roofer-safety. To these ends, a roofing shingle according to the embodiments may include a reinforcement core.

As an indicator of advantages of roof shingles and materials according to the embodiments over asphalt shingles, comparison of the different shingles' granular abrasion may be informative. Asphalt shingles exhibit high granule abrasion; that is, large amounts of granules may flake off from, and incrementally degrade the structural integrity of, asphalt shingles due to inclement weather and other natural abrasive erosional and structure-challenging forces. Conversely, roof shingles according to the embodiments exhibit low granule abrasion, with granules not appreciably flaking off (and with shingles remaining robust) even when the roof shingles are subjected to hail, high winds, heavy rains, sunlight illumination, and other natural abrasive erosional and structure-challenging forces.

A method of manufacturing a roofing tile may include manufacturing a reinforcement core. The method may also include molding a selected polymeric material. The molded material may include a cavity formed therewithin. The cavity may be configured for receiving fixed placement of the reinforcement core in the cavity.

The polymeric material may include a reveal and a conceal. The reveal may be visible when the roofing tile is installed. The conceal may be covered by an upslope adjacent roofing tile when the roofing tile is installed.

The method may further include forming, on the reveal, an upward facing surface. The upward facing surface may include a step-top texture region and a step-bottom texture region. The upward facing surface may also include a relief between the step-top texture region and the step-bottom texture region that creates a visible shadow line between the step-top texture region and the step-bottom texture region.

The step-top texture region may include a top surface with first random-depth granules. The step-bottom texture region may include a top surface with second random-depth granules.

The relief may be formed, at least in part, from a difference in substrate thickness between a substrate thickness under the step-top texture region and a substrate height under the step-bottom texture region. In some embodiments, the difference is greater than 1.0 mm.

### BRIEF DESCRIPTION OF THE DRAWINGS

The objects and advantages of the invention may be apparent upon consideration of the following detailed description, taken in conjunction with the accompanying drawings and in which:

FIG. 1 shows an illustrative diagram in accordance with principles of the disclosure;

FIG. 2 shows another illustrative diagram in accordance with principles of the disclosure;

FIG. 3 shows an illustrative diagram of roof shingles in accordance with the disclosure;

FIG. 4 shows an illustrative diagram of a roof shingle in accordance with the disclosure; and

FIG. 5 shows an illustrative diagram of another roof shingle in accordance with the disclosure.

FIG. 6 shows a top-down view of an illustrative roof shingle in accordance with the principles of the disclosure.

FIG. 7 shows a perspective view of an illustrative roof shingle in accordance with the principles of the disclosure.

FIG. 8 shows a blown-up view of a portion of the tile shown in FIG. 7.

FIG. 9 shows a blown-up view of a portion of the portion of the tile shown in FIG. 8.

FIGS. 10A-10B shows a top-down view, and a side view, of an illustrative hip/ridge roof shingle in accordance with the principles of the disclosure.

FIG. 11 shows a blown-up view, having an exploded sub-portion, of a portion of the tile shown in FIG. 10B.

FIG. 12 shows a blown-up view of a portion of the tile shown in FIG. 11.

FIG. 13 illustrates four views of various injection-molding gate positions and shows how particles flow through an illustrative portion of a tile in accordance with the principles of the disclosure.

FIG. 14 illustrates a conventional co-injection process that may be used for manufacturing roofing tiles in accordance with the principles of the disclosure.

FIG. 15 shows a perspective view of another illustrative roof shingle in accordance with the principles of the disclosure.

FIG. 16 shows a cutaway view taken from B-B of FIG. 15 of the tile shown in FIG. 15.

FIG. 17A shows a perspective view of an illustrative reinforcement bar in accordance with the principles of the disclosure.

FIG. 17B shows a top-down view of an illustrative reinforcement bar in accordance with the principles of the disclosure.

FIG. 18 shows a perspective view of an illustrative tile in accordance with the principles of the disclosure.

FIG. 19 shows an enlarged portion of the lattice-like pattern shown in FIG. 18.

### DETAILED DESCRIPTION OF THE DISCLOSURE

Roof shingles and methods of production thereof are provided.

The roof shingles may include a “ridge shingle” (also known as a “ridge cap”). The ridge shingle may be configured to be affixed to a roof ridge where two slopes (or facets) of a roof meet in a horizontal configuration. The roof ridge may present along the peak of a sloped roof. The ridge shingle may straddle the ridge. The ridge shingle may be scored to bend across the ridge.

The roof shingles may include a “hip shingle” (also known as a “hip cap”). The hip shingle may be configured to be affixed to a roof geometry where more than two slopes (or facets) of a roof meet in a non-horizontal configuration. The more than two roof slopes (or facets) may meet at the hip of a “hip roof.” The hip of a hip roof may present a “hip geometry.” The hip shingle may straddle the hip geometry of the hip roof. The hip shingle may conform to the hip geometry of the hip roof.

A term used herein encompassing “hip shingle” and/or “ridge shingle”: “hip/ridge single.”

The roof shingles may include a shingle that is not a hip/ridge shingle, but rather a “field shingle.” The field shingle may be configured to lie flat upon a planar roof section when installed. The field shingle may be configured to lie at least approximately parallel to the planar roof section when installed. The field shingle may typically not be used to span multiple roof slopes (or facets). The field shingle may also be used to span multiple roof slopes (or facets), e.g., in “valley” configurations, where field shingles bridge between facets.

The roof shingles may include EPDM or other suitable materials as disclosed herein. An EPDM roof shingle, according to some embodiments, may include EPDM with an ethylene content between about 45 and about 75 mol %. The EPDM roof shingle, according to some embodiments, may include EPDM with a diene content between about 1 and about 12 mol %. Representative dienes that may comprise the EPDM terpolymer include dicyclo-pentadiene and vinyl- and/or ethylidene-norbornene.

The roof shingle may include EPDM with, e.g., about 60 mol % ethylene, about 38.5 mol % propylene, and about 1.5 mol % diene.

The EPDM roof shingle, or roof shingles made from one or more other suitable materials, may possess Shore A hardness (Durometer based on test ASTM D2240) from about 55 to about 85, and most preferably between 73 and 80. The EPDM roof shingle may possess water vapor permeance (based on test ASTM E96/E96M) of a minimum of about 8 ng/[(Pa)(s)(m²)](about 0.14 U.S. perm).

The roof shingles, according to one or more of the embodiments, may possess inherent fungal resistance. The roof shingles may be chemically inherently anti-microbial. For example, after 21 days (based on test ASTM G21), EPDM roof shingles have exhibited no sustained growth or discoloration attributable to microbial growth.

Aerial imagery of roof shingles according to the disclosure may be used to test for discoloration from such microbial infestation as fungal and/or algal growth. Microbial growth may be detected using computer and artificial intelligence (“AI”) systems' analysis of digitized aerial roof imagery. Microbial growth may be indicated, for example, by visible (and other bands of) light radiation as streaking on the shingled roof Aerial imagery of roof shingles has not evidenced microbial growth.

Aerial imagery may also indicate undulation of roof shingles. Steel roof shingles, for instance, consisting typically of relatively thick steel sheets, can bend from but cannot fully return to their original flat form. Such a lack of plasticity may lead to undulations in a steel roof subjected to sheet-bending forces (severe hail, high windspeeds, etc.).

The roof shingles, with high plasticity, may not exhibit undulation even after being repeatedly bent and unbent. The roof shingles may exhibit flexibility. The roof shingles may be folded. The roof shingles may be bent. For example, roof shingles may be bent/unbent up to 100 times in testing without shingle failure.

The roof shingles may include a reinforcement core or, in the alternative, a reinforcement plate or bar.

The reinforcement core may include a metal reinforcement core. The reinforcement core may include a steel core. The reinforcement core may include a galvanized steel core.

The reinforcement core may include a sheet-metal reinforcement. The sheet-metal reinforcement may include steel. The steel of the sheet-metal reinforcement may include galvanized steel. The reinforcement core may include a thin metal sheet. The thin metal sheet may include steel. The steel of the thin metal sheet may include galvanized steel. The reinforcement core may include a metal strip. The metal strip may include steel. The steel of the metal strip may include galvanized steel. The reinforcement core may include any other suitable reinforcing material. Other suitable reinforcing material may include a polymeric core. The reinforcement core may not undergo plastic deformation under stress.

The reinforcement core may include 26-gauge to 30-gauge galvanized steel. The reinforcement core may include 28-gauge galvanized steel. Thickness of the 28-gauge galvanized steel may be about 0.02 inch.

The sheet-metal reinforcement may include 28-gauge galvanized steel. The thin metal sheet may include 28-gauge galvanized steel. The metal strip may include 28-gauge galvanized steel.

The reinforcement core may provide rigidity, structural integrity and longevity to the roof shingle to carry the roof shingle beyond a fifty-year lifespan. Advantages of the reinforcement core including galvanized steel may be strength, rigidity and structural integrity conferred by the galvanized steel toward prevention of wind-uplift; and the galvanized steel providing a durable platform for setting nails and other fasteners onto, into and or through the shingle.

The roof shingle, according to the various embodiments set forth herein, has been demonstrated in severe-weathering testing to exhibit advanced physical properties of over other roofing material. These properties may translate directly into roof installations with high resistance to ozone, UV radiation, diurnal (even precipitous) thermocycling, wind-uplift and hail impact.

The roofing tiles may be molded, over-molded, injection-molded, extruded, or molded in any other suitable fashion resulting in a polymer matrix surrounding and/or supporting the reinforcement core. Other suitable fashion of molding polymers and/or materials about the reinforcement core may include compression-molding. The reinforcement core may be laminated by the polymers. The reinforcement core may be enclosed within the polymer matrix. The reinforcement core may be integrated within the polymer matrix.

The reinforcement core may be embedded within the polymer matrix. The polymer matrix may be molded above the reinforcement core. The polymer matrix may be molded below the reinforcement core. The polymer matrix may be molded to completely envelop the reinforcement core.

The polymer matrix may underlie the reinforcement core, presenting, when the roof shingle is installed, a roof substrate-facing surface. The polymer matrix may overlie the reinforcement core, presenting, when the roof shingle is installed, an outward-facing roof shingle surface.

An adhesive sealant may be applied to the substrate-facing surface for binding the roof shingle to the roof substrate (as is found, for example, the starter course of shingles). The adhesive sealant may be applied to the substrate-facing surface for adhering the roof shingle to the outward-facing surface of a downslope adjacent roof shingle. The adhesive sealant may be activated by heat. The adhesive sealant may be activated by ambient atmosphere. The adhesive sealant may be made active when the roof shingle is produced. The adhesive sealant may be made active just prior to affixing the roof shingle.

The substrate-facing surface of the roof shingle may bear adhesive tabs. The adhesive tabs may lie along the substrate-facing surface of the reveal of the roof shingle. The adhesive tabs may lie spaced along the substrate-facing surface of the reveal of the roof shingle. The adhesive tabs may bear the adhesive sealant.

The adhesive sealant may be covered with a removable liner sheet of plastic (e.g., including vinyl, such as PVC, or other suitable contact paper-like material), thereby preventing unintentional contact of the adhesive sealant with another surface. The removable liner sheet of plastic may be configured to be removed just prior to affixment of the roof shingle, thereby exposing the adhesive sealant to be available for affixment of the roof shingle to another surface.

The removable sheet plastic may protrude beyond a bottom edge of the reveal's substrate-facing surface of the roof shingle. The removable sheet plastic may be termed an “adhesive protrusion tab.” The adhesive protrusion tab may be configured to be readily observable, even under potentially challenging roofing lighting conditions, to an observer looking down upon the upward-facing surface of the roof shingle. The adhesive protrusion tab may be brightly colored.

The reinforcement core of the roof shingle may bear nail-hole location marks indicating locations for driving nails through the conceal of the roof shingle and into the roof substrate. The reinforcement core of the roof shingle may include holes configured to accept nails driven through the of the outward-facing surface of the conceal of the roof shingle and into the roof substrate. The outward-facing surface of the conceal of the roof shingle may bear marks configured to indicate nail locations. The marks may be spaced evenly along the reinforcement core in a line paralleling the bottom edge. The holes may be spaced evenly along the reinforcement core in the line paralleling the bottom edge. The marks may be spaced evenly along the outward-facing surface of the conceal of the roof shingle, in the line paralleling the bottom edge.

The roof shingles may include a plurality of granules. The plurality of granules may be featured on the outward-facing surface of the reveal. The plurality of granules may be located on at least the portion of the outward-facing surface of the reveal.

The plurality of granules may be injection-molded into at least the portion of the surface of the reveal. The plurality of granules may be over-molded onto at least the portion of the surface of the reveal. The plurality of granules may be adhered to at least the portion of the surface of the reveal.

A portion of the plurality of granules may be featured on the conceal. The portion of the plurality of granules may be located on the conceal.

The plurality of granules may be applied to roof shingles by use of primer, rubber cement, spray, granule brush, and/or any other suitable bonder, method or applicator. A pre-determined amount of post-application time, such as five minutes or some other suitable time period, may be used to achieve adherence of the plurality of granules to the roof shingle.

The plurality of granules may provide improved traction upon a roof shingle. The plurality of granules may provide enhanced friction to facilitate walking on the roof shingles. Facilitating walking on the roof shingles may be particularly important on steep-slope roofs.

The roof shingles may feature different kinds of granules. Different kinds of granules may provide different roof shingle aesthetics. The plurality of granules may differ in granule color. Color variation of granules may alter the way ambient light is perceived after the light illumines the roof shingle. The plurality of granules of the roof shingle may include, for example, a choice of a variety of different colors of granules. The plurality of granules of the roof shingle may include at least one of the variety of different colors of granules.

The plurality of granules may differ in granule size. The plurality of granules may include various sizes of granules. The plurality of granules may include granules having, for example, a mesh size, sieve size, or diameter from about 0.5-2.5 mm.

A fire rating class of the roof shingle may be determined by a flame test. The plurality of granules may have a Class A fire rating. The roof shingle may have a Class B fire rating. The roof shingles may achieve a Class A fire rating because of the Class A fire rating of the plurality of granules located on the roof shingles.

Roof shingles, according to the embodiments, may be suitable for ready deployment of leading-edge interlocks, often useful where a downslope roof shingle interlocks (also adjoins, abuts or overlaps) with an upslope roof shingle. Deploying a roof shingle interlocks may include using an adhesive sealant to seal the interlock. The adhesive sealant may include tape. The tape may be double-sided. The adhesive sealant may include any other suitable means of adherence.

The roof shingles may be furnished with a wind warranty (yrs) in a range of 10-100 years. The roof shingles may be furnished with a wind warranty (yrs) of 50 years.

The roof shingles may be furnished with a wind warranty (mph) in a range of 10-300 mph. The roof shingles may be furnished with a wind warranty (mph) of 200 mph.

The roof shingles may achieve a Class Afire rating. The roof shingles may achieve a hail impact resistance warranty. The roof shingles may achieve an algae-resistance warranty. The roof shingles may achieve Florida product approval. The roof shingles may achieve Miami-Dade product approval. The roof shingles may achieve high velocity hurricane zone (“HVHZ”) approval. The roof shingles may be priced within a standard consumer price tier. The roof shingles may provide asphalt shingle aesthetics. The roof shingles may be sustainable and recyclable.

The roof shingles may include a mix of different kinds of granules. granules may provide different kinds of color for roof shingle aesthetics. Color variation of granules may change the way light hits the roof shingle. For example, a roof shingle may possess a variety of different colors of granules. The plurality of granules may include various sizes of granules. For example, the plurality of granules may have a mesh size, sieve size, or diameter from about 0.5-2.5 mm.

The roof shingles may be manufactured in various thicknesses. For example, a bottom layer of the roof shingle may be about 1/16 inch thick and a top layer of the roof shingle may be about ⅛ inch thick. The roof shingle may be injection-molded, compression-molded or otherwise produced to achieve the varying degrees of thickness.

The roof shingles may be manufactured with various rubber content. The roof shingles may be manufactured with rubber of various percentages of ethylene, of propylene and of dienes. The roof shingles may be manufactured with various dienes. The roof shingles may be manufactured with various degrees of vulcanization. The roof shingles may be manufactured with material containing various content of filler (such as reinforcing and/or colorant fillers). The roof shingles may be manufactured with material of various degrees of tackiness.

Roof shingle production may be economically efficient. Roof shingle roof-use may be economically efficient. By contrast, other materials for roof shingles, such as silicone and sheet metal, may not be economically efficient in production or roof-use.

The roof shingles may feature insulative properties. The roof shingles may provide varying degrees of insulation R-values. The roof shingles may be certified energy efficient. The roof shingles may provide a saving in energy efficiency for reduction of air conditioning and/or heating costs. A roof covered in the roof shingles may provide one or more kilowatt-hour in cost savings per month in heating/cooling costs.

The roof shingles may be suitable for basic shingle installation. Basic shingle installation is similar in type and in sequence of activities involved in asphalt shingle roof installation.

Roof shingles may provide vibration-dampening. Vibration-dampening may yield a quieter roof (in comparison, for instance, to an asphalt shingle roof) due to soft/flexible characteristics of polymers.

Standard commercial solar panels may be installed on the roof shingles. Solar panels may typically be installed with brackets that pierce underlying roof shingles and affix to underlying wood substrate. An advantage of roof shingles with respect to solar panels is that the polymer matrix, according to the embodiments, may close about the piercing, providing protection from water entering the hole cause by the installation bracket.

Roof shingles may be produced by molding, bulk, compression, and/or injection-molding. Sheets of polymer may be laminated together to produce roof shingles.

Roof shingles may be produced by calendering. Roof shingles may include a polymer material and reinforcement core that are calendared together. Two (or more) sheets of polymer, with a reinforcement core between the sheets, may be fed together into calendering rolls. This process may produce a long run of a “sandwich” sheet of polymer and reinforcement core materials, and a reinforcement core sheet. The sandwich sheet may be pressed thin by the calendering rolls.

The reinforcement core sheet may be cut to a standard size of a roof shingle. The calendering rolls may impart a geometric pattern on the reveal of the roof shingle. The calendering rolls may impart any markings required or desired on the roof shingle. Such markings may include markings for which printing is not suitable.

Roof shingles and methods of production may include vulcanization for granule application, by which the roof shingle dienes form cross-links between linear polymer sections. Roof shingle vulcanization may yield enhanced properties such as increased rigidity and durability, and improved mechanical and electrical properties. Vulcanization of roof shingles may create strong bonds between a substrate and a plurality of granules. Vulcanization may result in a high retention of granules on the roof shingles.

Hips and ridges may be most prone to wind damage because vortices of wind are formed at roof hips and ridges due to differentials in air pressure at those locations. Wind gusts may be concentrated and intense at the hips and ridges. Typically, any roof structure that is not a field shingle has usually been considered a roof accessory, thus leaving hip/ridge shingles to be considered “roof accessories” that have not usually been tested for failure.

Other roof accessories may include flashings, pipes, vents, ridge vents and valley metal. Roof accessories are commonly primary failure points for roofing systems. For example, a low profile flashing may be provided to protect roofs from wind gusts up to 70 mph, while a relatively taller profile flashing may be provided for improved roof water shedding. Failure of these usually incompletely tested roof accessories may jeopardize a roof's integrity.

Hip/ridge roof shingles may include a smooth piece of molded roof shingle. A hip/ridge roof shingle may include four sides (left, right, reveal, and conceal). The hip/ridge roof shingle may include a reveal and a conceal. The reveal may be about 6 inches in vertical height (Y). The conceal may be about 6 inches in vertical height (Y). A vertical height (Y) of the conceal and the reveal combined may be about 12.0 inches.

The hip/ridge roof shingles may each include a conceal including an embedded reinforcement core. The reinforcement core may include a 28-gauge galvanized steel reinforcement core. The full conceal may include the reinforcement core. The reinforcement core may be embedded throughout the entire conceal.

The hip/ridge roof shingle's reveal may be coated with a plurality of granules on the reveal's top. The reveal may be coated with adhesive, such as EPDM adhesive, (or any other suitable sealing agent) on the reveal's bottom.

The hip/ridge roof shingles may each include a reveal including an adhesive strip. The adhesive strip may be attached to a substrate-facing surface of the full reveal. Upon installation, the reveal may achieve full adhesion to an underlying substrate.

The roof shingle may be scored linearly along a centerline. The hip/ridge roof shingles may be scored across a midline for directed bending. The field roof shingles may be scored across a midline for directed bending.

The hip/ridge roof shingle may cover the conceals of field shingles of the highest course (ridge course) of field shingles on each slope (or facet) adjoining the ridge. A reveal of the hip/ridge roof shingle may cover the conceals of the field shingles of the ridge courses adjacent/along and downslope from the ridge. A conceal of the hip/ridge roof shingle may be covered by a reveal of an adjacent and overlapping hip/ridge roof shingle affixed along the ridge.

The hip/ridge roof shingle may include four markings configured to indicate nail locations. The hip/ridge roof shingle may accept four nails. The hip/ridge roof shingle conceal may include nail locations on each of its sides (left and right).

The hip/ridge roof shingles may be configured to be affixed to a roof using two rows of nails. A first row of nails may be deployed in and through a reinforcement core of a hip/ridge roof shingle conceal. A second row of nails may be deployed in and through a reinforcement core of a hip/ridge roof shingle conceal.

A first edge of the hip/ridge roof conceal may be disposed orthogonal to the ridge. The first edge of the ridge-spanning hip/ridge roof conceal may overlap field shingles already installed in ridge courses installed on both roof slopes adjoining the ridge.

The first row of nails may be deployed on both sides of the ridge at, e.g., 0.5 inch-1.0 inch from the first edge of the hip/ridge roof shingle conceal. The second row of nails may be deployed at, e.g., 0.5 inch-1.0 inch, from a second edge of the hip/ridge roof shingle conceal. The second edge may be largely parallel to the first edge. The nails may penetrate through upslope sections (near the ridge) of the field shingles of the ridge courses on both side of the ridge.

Alternatively: The first edge of the hip/ridge roof conceal may be disposed parallel the ridge. The first edge of the hip/ridge roof conceal may overlap field shingles already installed in a ridge course installed on a first slope adjoining the ridge. The first row of nails may be deployed on the side of the first slope at, e.g., 0.5 inch-1.0 inch from the first edge of the hip/ridge roof shingle conceal. The first nails (those associated with the first edge) may penetrate through an upslope section (near the ridge) of the field shingles of the ridge course on the first slope. The second row of nails may be deployed at, e.g., 0.5 inch-1.0 inch from an edge of the hip/ridge roof shingle conceal disposed largely parallel to the first edge and overlapping field shingles already installed in a ridge course installed on a second slope adjoining the ridge. The second nails (those associated with the second edge) may penetrate through an upslope section (near the ridge) of the field shingles of the ridge courses on the second slope.

Upon completion of installation of a shingle roof, all fasteners and nails on the hip/ridge roof shingles may be concealed.

The hip/ridge roof shingle may include a rigid core. The rigid core may be set back 0.1 inch-0.5 inch from an edge of the hip/ridge roof shingle.

Hip/ridge roof shingles may be produced by calendering. Hip/ridge roof shingles may include a reinforcement core that are calendared together.

High velocity wind resistance may be a characteristic of roof shingles. Roof shingles may be certified for high velocity and wind resistance.

Malleability and thickness of the roof shingles may also be set at manufacture.

The roof shingles may include marks configured for locations of nails. The marks configured for locations of nails may be located on the conceal. The marks configured for locations of nails may include 6 marks. The marks configured for locations of nails may be spaced about 5 inches-7 inches apart from one another.

Roof shingles may be configured to be affixed to a roof using two rows of nails. A first row of nails may be deployed in a reinforcement core of a roof shingle at about 0.5 inch-2.0 inches from an edge of the reveal. And a second row of nails may be deployed in the conceal of the roof shingle 0.5 inch-2.0 inches from an edge of the roof shingle. The second row of nails, in the conceal of the roof shingle, may come from a first row of nails going through a reinforcement core in an upslope roof shingle. Upon installation of the roof, all fasteners and nails on the roof shingles may be concealed.

Adhesive sealant may be deployed about 0.5 inch into the reveal from a leading edge of the roof shingle. The leading edge of the roof shingle may form one edge of the reveal. The adhesive sealing may be sealed with heat dissipating varnish. The adhesive sealing may seal to prevent water seeping underneath the EPDM roof shingle. The adhesive sealing may help to make the roof shingle immune to wind-borne debris and seeds implanting in the roof. Further, rubber is self-sealing, which may further prevent water and moisture ingress.

Physical dimensions of a roof shingle according to the disclosure may include horizontal length (X) along a horizontal axis, vertical height (Y) along a vertical axis, and depth (Z) along a depth axis.

The adhesive sealing may be a suitable bonding adhesive strip. The bonding adhesive strip may be about a 1-3-inch range in vertical height (Y). The bonding adhesive strip may be about 1.5 inches in vertical height (Y). An edge of the adhesive strip may be located about 6-12 inches away from the reveal.

The reinforcement core may be about 0.01-0.05 inch thick. The reinforcement core may run about 35-40 inches along the horizontal length (X) of the roof shingle.

The surface of the reveal may include geometric tabs. A shape of the geometric tabs may be, for example, rectangular, pentagonal, trapezoidal, circular, polygonal, or any other suitable shape. The geometric tabs may be configured to alternate with geometric tabs of an upslope adjacent roof shingle. The geometric tabs may be configured to alternate with geometric tabs of a downslope adjacent roof shingle.

The geometric tabs may be configured to be about 4-5 inches in horizontal length (X). The reveal of the roof shingle may be configured to be about 5-7 inches in vertical height (Y).

The roof shingle may be operable for use on a steep-slope roof. The steep-slope roof may have a pitch of greater than or equal to 2:12 roof pitch. A 2:12 roof pitch indicates an incline or 2 inches for every 12 inches of horizontal span. The steep-slope roof may have a pitch of between 2:12 and 24:12.

The roof shingle may include a drip edge. “Drip edge” may be a product available in the market. A drip edge may be an angled piece (e.g., “L” shaped) of metal flashing installed at an edge of a roof. The roof shingle may include an adhesive starter strip.

The adhesive starter strip may include a polymer. The adhesive starter strip may include an adhesive backing for adhesion to a standard underlayment and/or drip edge. The adhesive starter strip may be continuous (e.g., a roll of polymer) or segmented (e.g., individual segments of polymer) with adhesive backing for either.

The roof shingle may include polymer-polymer bonding for adhesion. The roof shingle may adhere to an underlayer, e.g., the roof shingle may bind to bottom layer or substrate. A first row of roof shingles may fasten through an underlayer into a roof deck.

The roof shingle may include, in certain embodiments, an adhesive protrusion tab. The hip/ridge shingles may also include, in some embodiments, an adhesive protrusion tab.

The adhesive protrusion tab may be an adhesive contact paper that prevents the adhesive from adhering to other materials until the adhesive contact paper is intentionally removed. The adhesive protrusion tab may be bright in color. The bright color of the adhesive protrusion tab, or absence thereof, may indicate a visual determination that the contact paper has been removed and shingle installation is properly executed. The adhesive itself may terminate just before the leading edge of the shingle. The brightly colored adhesive contact paper, the adhesive protrusion tab, may protrude about 0.25 inch-0.5 inch from a leading edge of the shingle. The adhesive contact paper may be printed with graduated tool cut marks.

The roof shingle may be operable for use on any building or structure. The roof shingle may be operable for use, for example, on buildings for golf courses, warehouses, offices, banks, distilleries, carports, retail stores, car washes, car dealerships, car showrooms, garages, car shops, storage facilities, aircraft hangers, commercial, transportation, clinics, cattle barns, hospitals, gyms, schools, education, religious services, sports, including, but not limited to, soccer, indoor hockey, basketball, pickleball, and tennis; on accessory dwelling units; on residential facilities; on facilities for industrial and/or chemical production or storage, for oil/gas, production, for manufacturing, farm storage, self-storage, equestrian use and/or agricultural use.

Methods of producing a roof shingle are provided. The methods may include molding polymer above a reinforcement core. The methods may include molding polymer below a reinforcement core. The methods may include embedding the reinforcement core within a polymer matrix. In some embodiments, methods may include embedding the reinforcement core between layers of polymer. In some embodiments, the reinforcement core may include a metal core. The metal core may include, for example, galvanized steel.

The methods may include producing a roof shingle. The roof shingle may include an outward-facing surface. The roof shingle may include a substrate-facing surface. The outward-facing surface may include a reveal. The outward-facing surface may include a conceal. The reveal may be visible when the roof shingle is installed. The conceal may be covered by an upslope adjacent roof shingle when the roof shingle is installed.

The methods may include molding a plurality of granules on at least a portion of a surface of the reveal. The methods may include adhering a plurality of granules to at least a portion of a surface of the reveal. The plurality of granules may be located on at least a portion of the surface of the reveal.

The methods may include applying an adhesive sealant to the substrate-facing surface for binding the roof shingle to a downslope adjacent roof shingle or a substrate. The methods may include activating the adhesive sealant by heat. The methods may include activating the adhesive sealant by removing a contact sheet and/or exposing the adhesive to ambient atmosphere. The methods may include providing an adhesive sealant that is already active.

The methods may include producing a roof shingle that achieves a Class A fire rating. The methods may include producing a plurality of granules that achieve a Class A fire rating. The methods may include producing a roof shingle that achieves some or all of a hail impact resistance warranty, an algae-resistance warranty, a Florida product approval or other state product approval, a Miami-Dade approval or other county product approval, a high velocity hurricane zone (“HVHZ”) approval, entry into a standard consumer price tier, asphalt shingle aesthetics, high sustainability and high recyclability. The methods may include producing a roof shingle that allows for basic roof shingle installation as widely practiced in asphalt tile roofing installations.

The methods may include producing a roof shingle including marks configured for locations of nails. The marks configured for locations of nails may be located on the conceal. The marks configured for locations of nails may include six (6) marks. The marks configured for locations of nails may be spaced about 5-7 inches apart from one another.

The methods may include sealing the adhesive sealant with heat dissipating varnish. The methods may include applying an adhesive sealant up to about 0.5 inch from a leading edge of the roof shingle into the reveal. The leading edge of the roof shingle may constitute one edge of the reveal.

The methods may include producing a roof shingle with a reinforcement core about 0.01-0.05 inch thick in depth (Z). The methods may include producing a roof shingle with a reinforcement core that runs about 35-40 inches along the horizontal length (X) of the roof shingle.

The methods may include producing a roof shingle with a reveal including geometric tabs. The geometric tabs may be, for example, rectangular, pentagonal, trapezoidal, circular, polygonal, or other relevant geometrical shape. The geometric tabs may be configured to alternate with geometric tabs of an upslope adjacent roof shingle. The geometric tabs may be configured to alternate with geometric tabs of a downslope adjacent roof shingle. The geometric tabs may be configured to be about 4-5 inches in horizontal length (X).

The methods may include producing a roof shingle with a reveal configured to be about 5-7 inches in vertical height (Y). The methods may include producing a roof shingle operable for use on a steep-slope roof. The steep-slope roof may have a pitch of greater than or equal to 2:12 roof pitch. A 2:12 roof pitch indicates an incline or 2 inches for every 12 inches of horizontal span.

The methods may include producing a roof shingle with EPDM rubber, and/or other suitable material, and a reinforcement core for fastener retention. The reinforcement core may include a metal core. The metal core may include galvanized steel. The metal core may be, for example, a 28-gauge galvanized steel core.

An adhesive may be used to apply the plurality of granules to at least a portion of the surface of the reveal. In some embodiments, an adhesive may first be applied to a portion of the surface of the reveal. Then the plurality of granules may be applied to the adhesive on the portion of the surface of the reveal. In other embodiments, the adhesive may first be applied to the plurality of granules. For example, the adhesive may coat the plurality of granules. Then the plurality of adhesive-coated granules may be applied to an adhesive-coated portion of the surface of the reveal.

Roof shingles according to the disclosure may include butyl adhesive sealants. Butyl adhesive sealants may include, for example, butyl rubber, butylene, and polyisobutylene.

The granules may be fire resistant. The granules may confer fire resistance to the roof shingles.

In some embodiments, the roof shingle may include pure EPDM. Pure EPDM may be greater than 99% EPDM by weight. EPDM may be chemically bonded to itself. The roof shingle may include other materials, including other polymers, rubbers, recycled tires, synthetic materials, and thermoplastics. The roof shingle may include any suitable percentage of EPDM and/or other polymers.

The methods may include molding roof shingles. Molding roof shingles may reproduce shapes and sizes of traditional asphalt shingles. Molding shingles may reproduce colors that are the same as, or similar to, colors that are currently in use on existing asphalt roof shingles.

The roof shingles may provide fire-spread resistance. The roof shingles may include shingle accessories, for example, flashings. Flashings may keep water out of the roof. Flashings may provide a secondary water barrier. The roof shingles may include accessories for plumbing stacks.

Roof shingles may include a plywood truss configuration. The plywood truss configuration may include plywood on an underlayer beneath at least part of a first course (a starter course) of roof shingles. The plywood may be about ⅝-¾-inch thick. The roof shingle may include peel and stick material for adhesion. The roof shingle may exhibit full adhesion and self-healing.

The roof shingles, according to the disclosure, may prevent ice damming. The roof shingles may prevent ice damming by shedding water effectively, since effective water shedding may help reduce the amount of moisture that sits on the roof and contributes to ice damming.

Roof shingles may be installed with proper overlap. Proper overlap may ensure the roof shingles are well-sealed. Proper overlap may help prevent water from getting under the roof shingles, which can contribute to ice dam issues. The roof shingles may be configured to be operable in cold weather climates.

The roof shingles may be operable for ease of transportation and manipulation. The roof shingles may be operable for skylights.

Fasteners penetrating a reinforcement core of an upslope roof shingle may also penetrate a conceal of a downslope roof shingle. Such a configuration including two rows of fasteners—one through the reinforcement core and one through the conceal—for each installed roof shingle may provide additional integrity and rigidity to the roof shingles when installed.

The adhesive sealant may be about 1-5 inches in vertical height (along the Y axis). The adhesive sealant may be about 3 inches in vertical height (Y). The adhesive sealant may be activated for lamination.

The roof shingles may include a chemically welded seam. The roof shingles may provide ease of installation. Ease of installation may include, for example, nailing the roof shingle to a substrate, peeling off wax coated paper revealing the adhesive sealant, and activating the adhesive sealant.

The roof shingles may be removed and/or uninstalled from a substrate. A challenge to uninstalling roof shingles may be ring-shank nails. Ring-shank nails may present greater retraction resistance than smooth-shank nails. A challenge to uninstalling roof shingles may be presented by a sealant strip at the leading edge of the roof shingles that may be bonded to an underlayment/drip edge flashing.

When large numbers of roof shingles are dislodged or irreparably damaged, the rest of the roof's roof shingles may need to be removed/uninstalled. This occurs because roof shingles include reinforcement core strips and may be bonded together with sealant. With the sealant bonding adjacent roof shingles, the roof may behave as a “monolithic” single system of roof shingles.

Installation of roof shingles upon a standard roof may take up to about eight hours or more. Removal and/or uninstallation, however, of those shingles may be much more efficient and less time-consuming if the shingles behave as a single system. Such removal and/or uninstallation may take as little as about 20 minutes. In some embodiments, removal and/or uninstallation of roof shingles may only require pedestrian hand tools available to non-professionals.

Any single roof shingle may be replaced and/or uninstalled on a roof. For example, an entire roof may not need to be replaced if one or more roof shingles become broken, defective, or dislodged.

The plurality of granules may be applied after the molding. The plurality of granules may be applied during the molding.

The plurality of granules may be provided upslope up to about 1 inch of the reveal. The plurality of granules may be provided upslope from the leading edge to prevent granules from “walking” downslope.

The plurality of granules may include a clay appearance. The plurality of granules may include pulverized clay. The plurality of granules may provide aesthetic texture to the roof shingle in a variety of colors and configurations. The plurality of granules may have colors that are identified using AI.

The roof shingles may accommodate solar panel configurations. The roof shingles may accommodate roof-mounted accessories. The roof-mounted accessories may include configurations identical to those accommodated by asphalt roof shingles.

The roof shingles may achieve wind uplift resistance. The roof shingles according to the embodiments were subjected to a wind/wind-driven rain test (see more detail below). The roof shingles passed the wind/wind-driven rain test with wind gusts up to at least 110 mph. The wind/wind-driven rain test was the TAS 100 test. (See https://www.intertek.com/building/standards/tas-100/.) The TAS 100 test is a standard test method for wind and wind driven rain resistance of discontinuous roof systems.

The TAS 100 procedure may provide a means for establishing discontinuous roof system resistance to wind-driven rain. A discontinuous roof system may include, for example, an underlayment and a prepared roof covering. Discontinuous roof systems may be, e.g., metal roof panels, metal shingles, asphalt shingles, roof shingles, and composite shingles.

The TAS 100 procedure includes spraying water on a specimen using a water spray rack. The water is sprayed at a rate of 8.8 inches of rainwater volume during each active spray interval. A wind generator is then used to generate wind speeds of 35 mph, 70 mph, 90 mph, and 110 mph for specified intervals with 10-minute periods of rest after each interval.

The TAS 100 test may verify whether the roof shingle system provides sufficient wind-driven rain resistance such that water does not permeate the roof deck sheathing. A comprehensive test report may be issued at the conclusion of the TAS 100 test. The TAS 100 test deck may incorporate eave, valley, and rake conditions. (An “eave” may include horizontal roof overhangs located at the bottom edge of a roof section. A “rake” may include sloped sections of overhangs that extend from eaves to a roof peak. A roof “valley” may include a location where two roof facets meet at a slope to form an interior angle.)

Corner and perimeter spacing may also be used for clips and fasteners, however, they may not be used for field spacing.

An exemplary embodiment of roof shingles was exposed to the TAS 100 test with the following conditions. First, the roof shingles were exposed to 8.8 inches of rainwater volume at 35 mph wind speeds for 15 minutes, followed by a 10-minute rest. Second, the roof shingles were exposed to 8.8 inches of rainwater volume at 70 mph wind speeds for 15 minutes, followed by a 10-minute rest. Third, the roof shingles were exposed to 8.8 inches of rainwater volume at 90 mph wind speeds for 15 minutes, followed by a 10-minute rest. Fourth, the roof shingles were exposed to 8.8 inches of rainwater volume at 110 mph wind speeds for 5 minutes. Finally, the TAS 100 test concluded showing the exemplary embodiment of roof shingles intact and undamaged.

Charts 1-3 illustrate data comparing one exemplary embodiment of a roof shingle as described herein (“EPDM Roof Shingle”) to other/competitor products including GAF's Timberline HDZ®, Owen Corning's Duration® Series, CertainTeed's Landmark® PRO, Tilcor's CF Shingle, F-Wave's Revia®, GEM's Euroshield, and Tamko's Proline® Titan XT®.

Chart 1 (Part A) illustrates data comparing the EPDM Roof Shingle to other/competitor products with respect to discontinuous system material, leading edge interlock, wind warranty (yrs), and wind warranty (mph).

CHART 1
EPDM Roof Shingle vs. Competitor Products (Part A)

| | | Discontinuous | Leading | Wind | Wind |
|---|---|---|---|---|---|
| | | System | Edge | Warranty | Warranty |
| Name | Product | Material | Interlock | (yrs) | (mph) |
| EPDM Roof | Shingle | Galv. Metal | EPDM | 50 | 200** |
| Shingle* | | Core EPDM | Tape | | |
| GAF | Timberline | Asphalt | Tar | 15 | 130 |
| | HDZ ® | | | | |
| Owens | Duration ® | Asphalt | Tar | 15 | 130 |
| Corning | Series | | | | |
| CertainTeed | Landmark ® | Asphalt | Tar | 15 | 130 |
| | PRO | | | | |
| Tilcor | CF Shingle | Galvanized | Mechanical | 50 | N/A |
| | | Metal | | | |
| F-Wave | Revia ® | Synthetic | Chemical | 15 | 130 |
| | | Polymer | | | |
| GEM | Euroshield | Synthetic | Mechanical | 50 | 90 |
| | | Polymer | | | |
| Tamko | Proline ® | Asphalt | Chemical | 15 | 160 |
| | Titan XT ® | | | | |

*As described herein
**Until deck failure

Chart 2 (Part B) illustrates data comparing the EPDM Roof Shingle to the other/competitor products with respect to wind speed class (mph), Class A fire rating, hail impact resistance, algae-resistance warranty, Florida product approval, and Miami-Dade product approval.

CHART 2
EPDM Roof Shingle vs. Competitor Products (Part B)

| | Wind | | | | | Miami- |
|---|---|---|---|---|---|---|
| | Speed | Class | Hail | Algae- | Florida | Dade |
| | Class | A Fire | Impact | Resistance | Product | Product |
| Name | (mph) | Rating | Resistance | Warranty | Approval | Approval |
| EPDM Roof | 151-190 | Yes | Yes | Yes | Yes | Yes |
| Shingle* | | | | | | |
| GAF | 151-190 | Yes | No | Yes | Yes | Yes |
| Owens Corning | 151-190 | Yes | No | Yes | Yes | Yes |
| CertainTeed | 151-190 | Yes | No | Yes | Yes | Yes |
| Tilcor | N/A | Yes | No | No | Yes | Yes |
| F-Wave | 151-190 | Yes | Yes | Yes | Yes | No |
| GEM | 90 | No | Yes | No | No | No |
| Tamko | 151-190 | Yes | No | Yes | Yes | Yes |

*As described herein

Chart 3 (Part C) illustrates data comparing the EPDM Roof Shingle to the other/competitor products with respect to high velocity hurricane zone (“HVHZ”) zone approved, consumer price tier, basic shingle installation, asphalt shingle aesthetics, and sustainable and recyclable.

CHART 3
EPDM Roof Shingle vs. Competitor Products (Part C)

| | HVHZ | Consumer | Basic | Asphalt | Sustainable |
|---|---|---|---|---|---|
| | Zone | Price | Shingle | Shingle | and |
| Name | Approved | Tier | Installation | Aesthetics | Recyclable |
| EPDM Roof | Yes | Standard | Yes | Yes | Yes |
| Shingle* | | | | | |
| GAF | No | Standard | Yes & No | Yes | No |
| Owens | No | Standard | Yes | Yes | No |
| Corning | | | | | |
| CertainTeed | No | Standard | Yes | Yes | No |
| Tilcor | Yes | High | No | No | Yes |
| F-Wave | Yes | Medium | Yes | No | Yes |
| GEM | No | Standard | Yes | No | Yes |
| Tamko | No | Standard | Yes & No | Yes | No |

*As described herein

Roof shingles and methods described herein are illustrative. Roof shingles and methods in accordance with this disclosure may now be described in connection with the figures, which form a part hereof. The figures show illustrative features of roof shingles and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Roof shingles may omit features shown or described in connection with illustrative roof shingles. Embodiments may include features that are neither shown nor described in connection with the illustrative roof shingles. Features of illustrative roof shingles may be combined. For example, an illustrative embodiment may include features shown in connection with another illustrative embodiment.

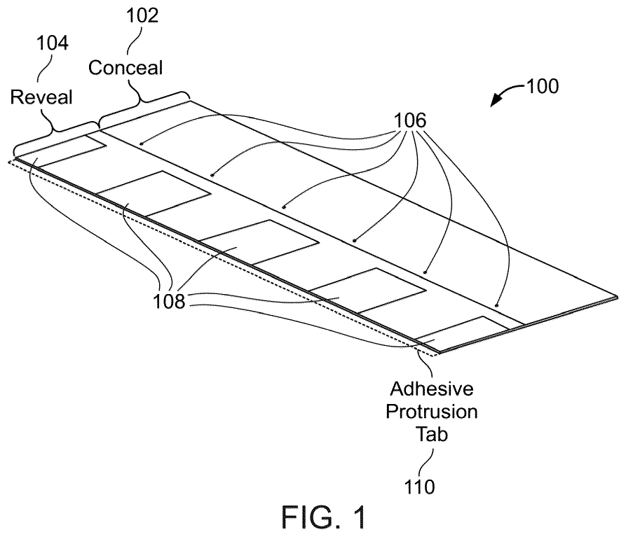

FIG. 1 shows roof shingle 100. Roof shingle 100 may include a conceal 102. Roof shingle 100 may include a reveal 104. Reveal 104 may remain visible after roof shingle 100 is installed. Conceal 102 may be covered, after roof shingle 100 is installed, by an upslope adjacent and overlapping roof shingle.

Conceal 102 may include marks 106. Marks 106 may be configured for indication of locations of nails. Reveal 104 may include geometric tabs 108. An adhesive protrusion tab 110 may protrude about 0.25 inch-0.5 inch from a leading edge of reveal 104.

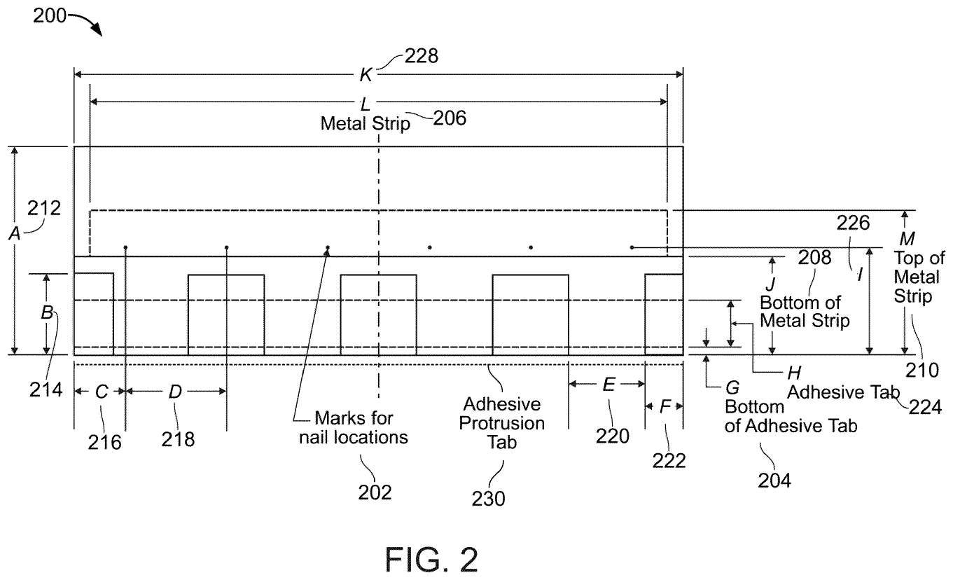

FIG. 2 shows roof shingle 200. Roof shingle 200 may include marks 202 configured to indicate nail locations. Marks 202 for nail locations may be disposed a distance D from one another. Roof shingle 200 may include a bottom 204 of adhesive tab 224.

Roof shingle 200 may include metal strip 206 as its reinforcement core. Metal strip 206 may include bottom 208. Metal strip 206 may include top 210.

Roof shingle 200 may be characterized, in part, by the following dimensions, locations, and/or features:
A 212—extension of roof tile 200 in “height,” i.e., orthogonal to a leading edge of roof shingle 200 (the leading edge depicted as a bottom edge of FIG. 2's depicted shingle);
B 214—extension of adhesive tab 224 in “height” from (in direction orthogonal to) the leading edge;
C 216—distance between a side edge (a side orthogonal to the leading edge) of roof shingle 202 and a mark 202 nearest the side edge;
D 218—distance between adjacent marks 202;
E 220—distance between facing edges of geometric accent configurations;
F 222—extension from a side edge of roof tile 200 (and parallel to the leading edge) of a geometric accent configuration with a side coextensive with the side edge;
G—bottom 204 of adhesive tab 224;
H—adhesive tab 224;
I 226—distance of marks 202 from the leading edge;
J—bottom 208 of metal strip 206;
K 228—extension of roof tile 200 in “width” (orthogonal to “length” direction A);
L—metal strip 206; and
M—top 210 of metal strip 206.

Approximate values associated with the dimensions, locations, and/or features shown in illustrative roof shingle 200 may be:
A 212—13.25 inches;
B 214—5.12 inches;
C 216—3.25 inches;
D 218—6.50 inches;
E 220—4.88 inches;
F 222—2.44 inches;
G 204—up to 0.5 inches from the leading (for instance, about 0.125 inches from the leading edge);
H 224—may extend “vertically” about 3.00 inches from G;
I 226—6.88 inches;
J 208—6.25 inches;
K 228—39.00 inches;
L 206 may extend “horizontally” about 37.00 inches; and
M 210—9.25 inches from the leading edge.

Adhesive protrusion tab 230 may protrude beyond the leading edge. Adhesive protrusion tab 230 may protrude about 0.25-0.5 inch from the leading edge. Adhesive protrusion tab 230 may include a brightly colored piece of contact paper (or other readily removable covering material, such as waxed paper) adhering to a back surface of adhesive tabs 224. Adhesive protrusion tab 230 may be removed exposing the substrate-facing adhesive portion of adhesive tabs 224 in preparation for affixment of roof shingle 200.

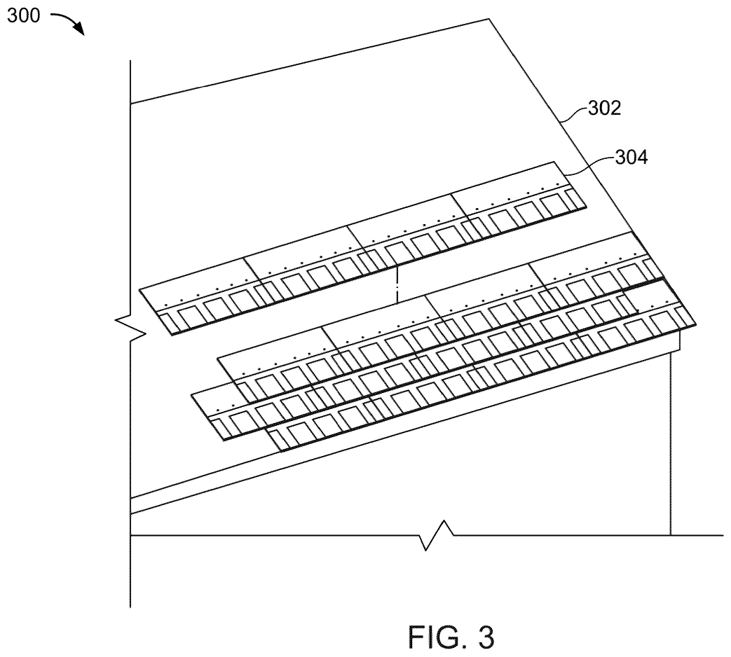

FIG. 3 shows roof configuration 300 according to the disclosure. Roof shingles 304 may be installed on roof 302. As shown in FIG. 3, horizontal placement upon roof 302 of courses of roof shingles 304 may be alternately offset.

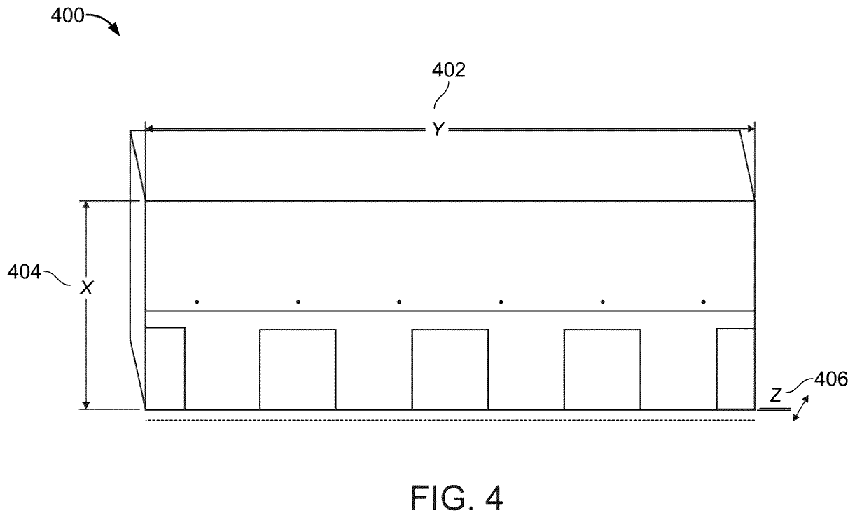

FIG. 4 shows roof shingle 400. A first extent of shingle 400 may be provided by distance (X) 404. A second extent, orthogonal to the first extent, of shingle 400 may be provided by distance (Y) 402. A thickness (or depth) of roof shingle 400 may be provided by distance (Z) 406. A forward edge of an adhesive protrusion tab (protruding from a leading edge shingle 400) may be depicted by a dashed line parallel to the leading edge.

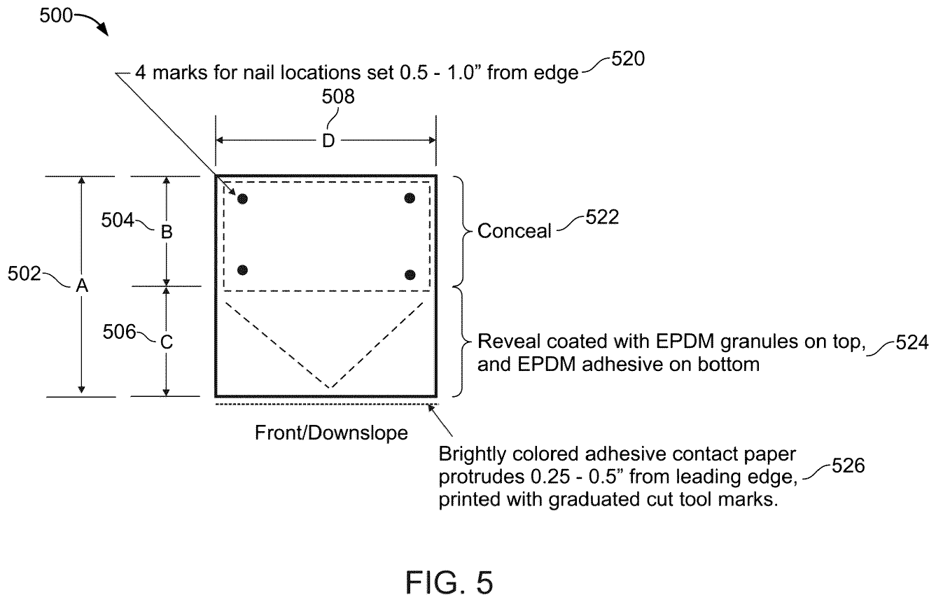

FIG. 5 shows roof shingle 500. Roof shingle 500 may be a ridge shingle. Roof shingle 500 may be hip shingle. Roof shingle 500 may be a hip/ridge shingle.

Roof shingle 500 may include a vertical height (A) 502. Vertical height (A) 502 may be about 12.0 inches. Vertical height (A) 502 may be divided into a vertical height (B) 504 and vertical height (C) 506. Vertical height (B) 504 may be about 6.0 inches. Vertical height (C) 506 may be about 6.0 inches.

Roof shingle 500 may include a horizontal length (D) 508. The horizontal length (D) 508 of roof shingle 500 may be about 12.0 inches.

Roof shingle 500 may include four marks 520 configured to indicate nail locations. The marks may each be set 0.5-1.0 inch from an edge of the shingle.

Roof shingle 500 may include conceal 522 corresponding in location and vertical height to (B) 504. Roof shingle 500 may include reveal 524 corresponding in location and vertical height to (C) 506. Reveal 524 may be coated with granules on a top, outward-facing surface. Reveal 524 may include an adhesive on a bottom, substrate-facing surface.

Roof shingle 500 may include a reinforcement core within conceal 522. Roof shingle 500 may be printed with graduated tool cut marks configured to facilitate fold reveal 524.

Roof shingle 500 may include adhesive protrusion tab 526. Adhesive protrusion tab 526 may include an adhesive contact paper. Adhesive protrusion tab 526 may protrude 0.25-0.5 inch from a leading edge of roof shingle 500. Adhesive protrusion tab 526 may be brightly colored for visibility. Adhesive protrusion tab 526 may be printed with graduated tool cut marks. Adhesive protrusion tab 526 may be included on the downslope portion of roof shingle 500. Adhesive protrusion tab 526 may be included on a substrate-facing surface (an undersurface) of reveal 524. Adhesive protrusion tab 526 may protrude from beneath reveal 524.

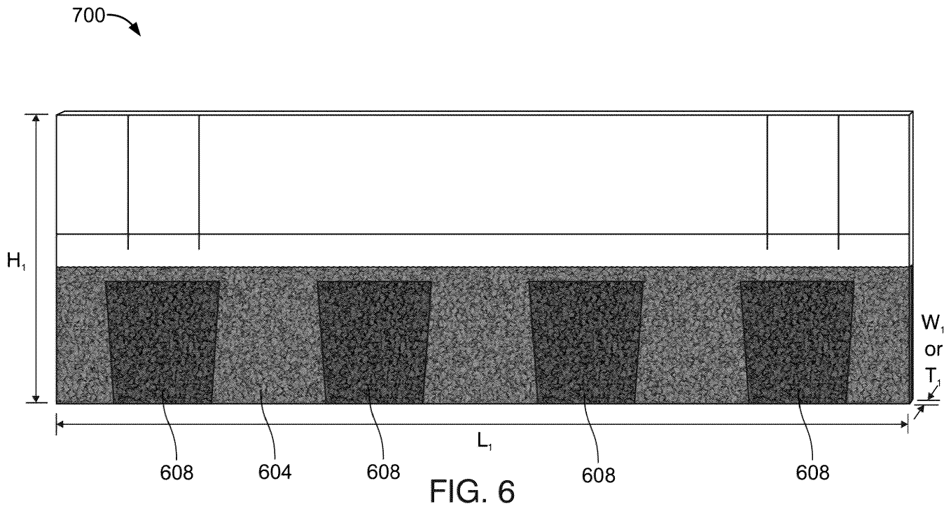

FIG. 6 shows a top-down view of an illustrative tile 600 (also referred to herein as a roof shingle) in accordance with the principles of the disclosure. The tile has an overall length L1, width W1, and height H1 (with L denoting length, W denoting width, and H denoting height or, alternatively, thickness). Trapezoidal indentations are identified by 608, and the area outside the trapezoidal indentations is identified by 604. In some embodiments, projections within trapezoidal indentations 608 have a random height up to about 2.5 mm above an underlying surface, while projections in the outside area 604 have a random height up to about 3.5 mm above a bottom surface. In some embodiments, projections within the trapezoidal indentations 608 and projections in the outside area 604 have substantially the same random height distribution relative to their immediately underlying surfaces, with the bottom surface within the trapezoidal indentations preferably about 1.0 mm thick and the bottom surface outside the trapezoidal indentations preferably about 2.5 mm thick. In any of the foregoing embodiments, the bottom surface may be built from a layer of material as disclosed herein.

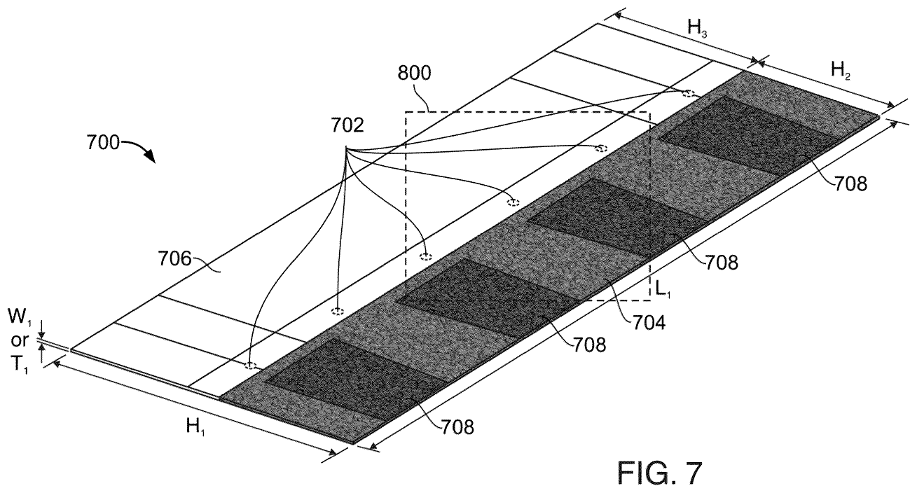

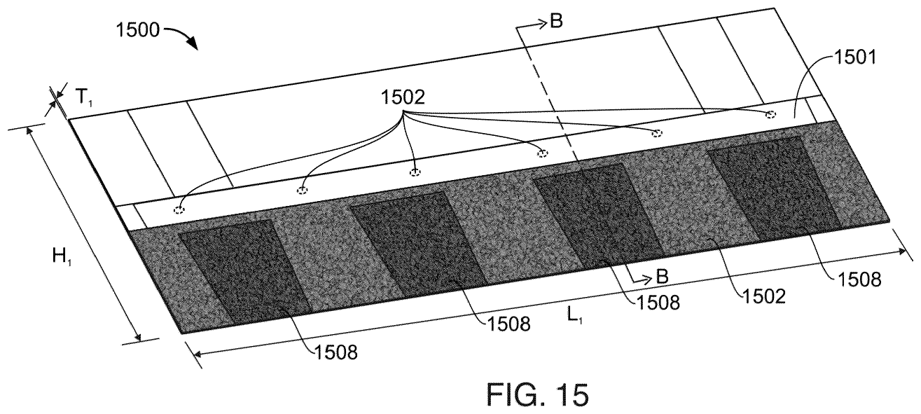

FIG. 7 shows a perspective view 700 of an illustrative tile, including installation and surface features. Marking for securing the tile with nails are identified at 702. The area outside the trapezoidal regions is identified as 704, while the interior of the trapezoidal regions is identified as 708. A concealment feature 706 is shown in relation to the surrounding surface. Nails are driven through the typically upslope “conceal” section of the shingle, so termed because that nail-bearing section is then covered and concealed by a “reveal” section of an adjacent and overlapping upslope shingle. The reveal typically remains uncovered. It should be noted that the section of the tile through which the nails are driven may be indicated in a reinforcement core when the reinforcement core forms the highest level of the conceal. This is shown, for example, in FIGS. 15, 16 and 17A-17B.

Following fastening of the nails to the conceal, the upslope shingle's reveal, covers and protects the nail-hole-bearing conceal of the downslope shingle.

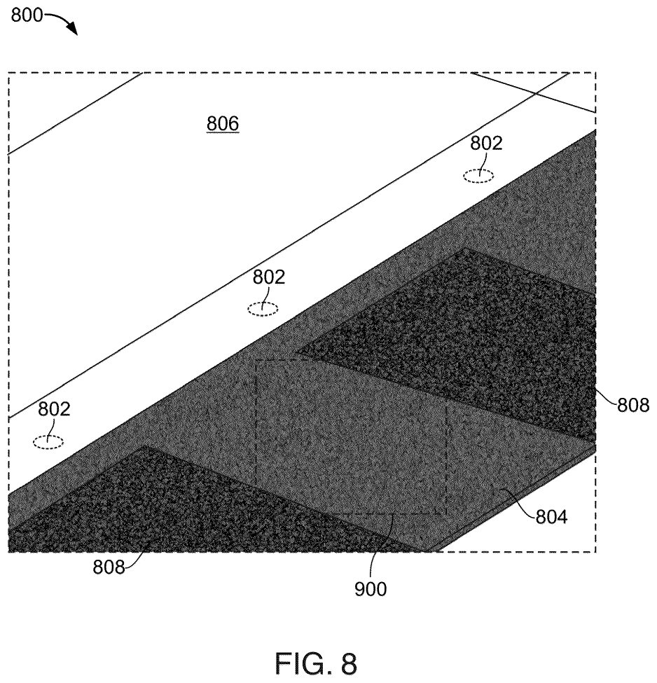

A zoomed-in cutout region 800 is indicated to show further detail in FIG. 8. Dimensional indicators, where labeled, follow the conventions that L denotes length, T denotes thickness, and H denotes height.

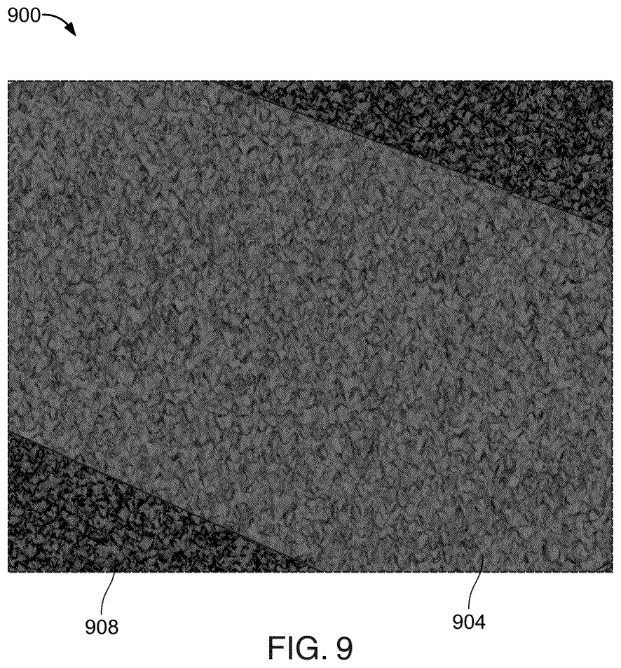

FIG. 8 shows a blown-up view of the cutout region 800 identified in FIG. 7, detailing local surface and installation features. Markings for driving nails through the tile are identified at 802. The area outside the trapezoidal regions is identified at 804 and the interior of the trapezoidal regions is identified at 808. A concealment feature 806 is shown adjacent to the nail-hole locations. A further zoomed-in region 900 is identified and is shown in greater detail in FIG. 9.

FIG. 9 shows a zoom-in of region 900 from FIG. 8 to highlight micro-texture and local geometry. The outside-of-trapezoid area within the zoomed region is identified at 904, and the inside-of-trapezoid area is identified at 908. Together, 900, 904, and 908 illustrate fine-scale transitions between outside and inside trapezoidal.

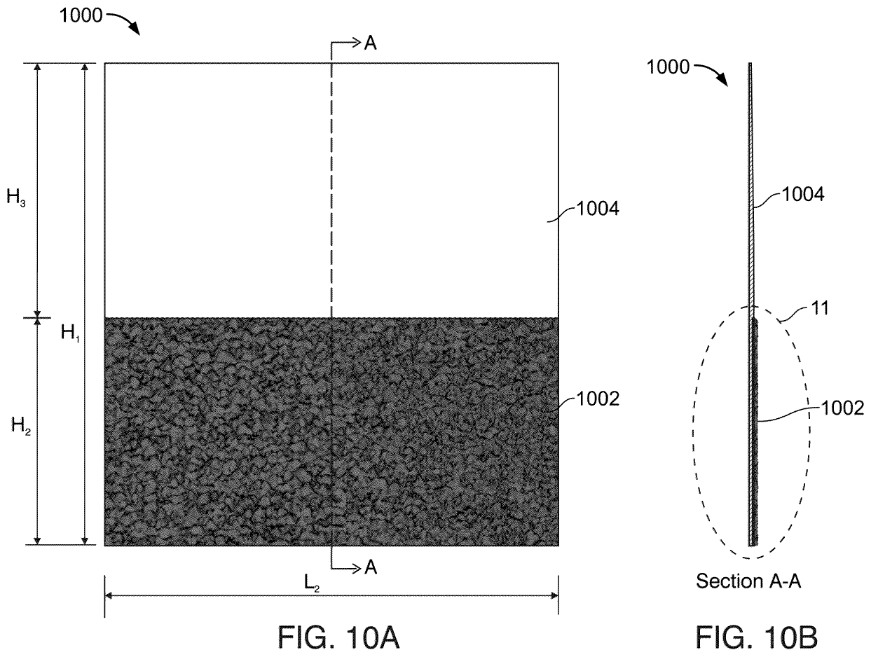

FIG. 10A shows a top-down (plan) view of an illustrative hip/ridge tile 1000. A reveal region 1002 is identified in plan, as is a conceal region 1004. Cross-section A-A runs through the middle of the hip/ridge tile to show internal relationships in a corresponding section view. Dimensional indicators include H1 (the overall height of the tile), H2 (the height of the reveal), H3 (the height of the conceal), and L2 (the overall length of the tile in this embodiment). Throughout, L denotes length, T denotes thickness, and H denotes height.

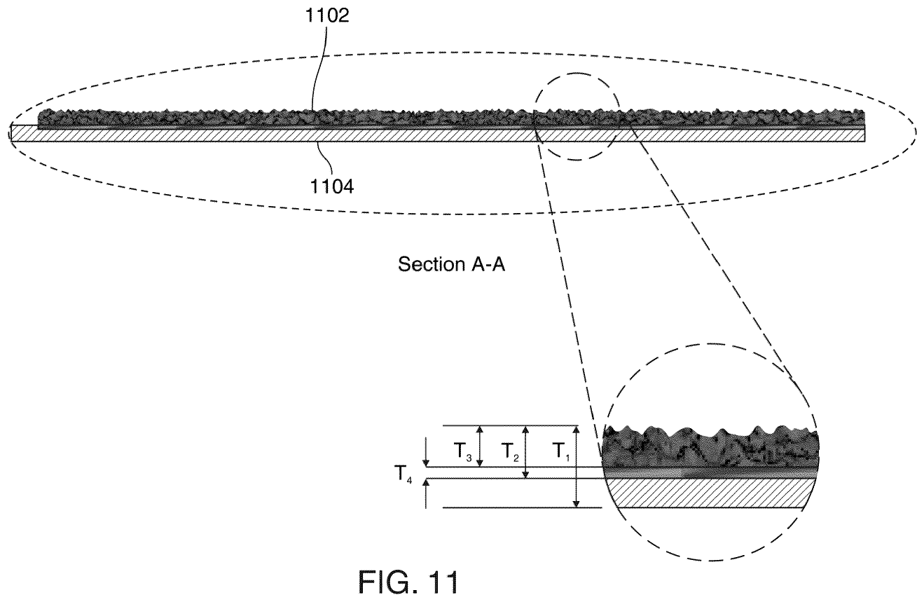

FIG. 10B shows a side view of the illustrative hip/ridge tile 1000 corresponding to FIG. 10A. The reveal region 1002 is shown with its depth/profile, and the conceal region 1004 is likewise identified. Element 11 indicates a zoomed-in portion that is presented in FIG. 11 for additional detail regarding surface textures and layer relationships along the reveal and adjacent regions.

FIG. 11 shows a blown-up side view, including an exploded sub-portion, of a portion of the tile shown in FIG. 10B. A rough surface on the reveal is identified at 1102, and the back side of the tile is identified at 1104. The enlarged portion calls out tile thickness relationships as follows: T1 denotes the tile thickness from the back side of the tile to the top of the rough surface of the reveal; T2 denotes the thickness from the bottom of the base layer of the reveal to the top of the rough reveal surface; T3 denotes the thickness from the top of the base layer of the reveal to the top of the rough reveal surface; and T4 denotes the thickness of the middle base layer. These dimensions illustrate layer stacking and texturing used to manage stiffness, aesthetics, and molding fidelity.

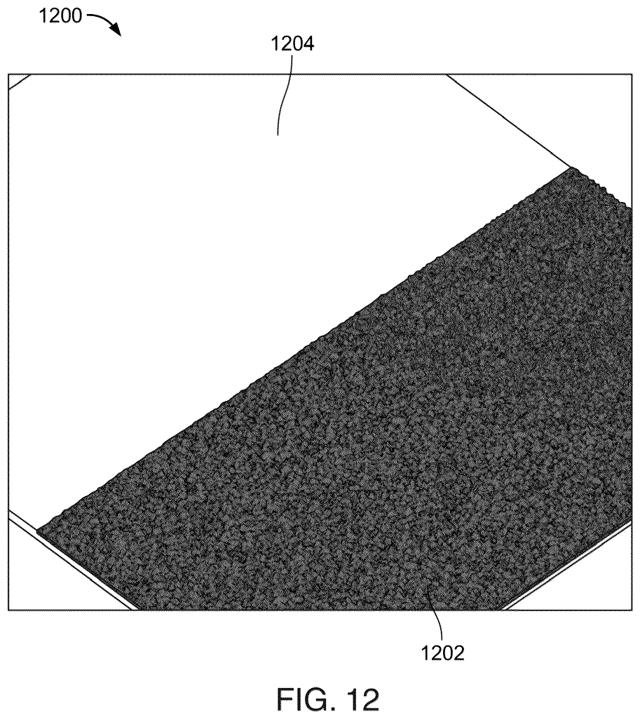

FIG. 12 shows a further blown-up view of a portion of the hip/ridge tile 1200, highlighting a reveal 1202 and a conceal 1204. The view details interface geometries, fillets, and transitions between the reveal 1202 and conceal 1204 that facilitate molding accuracy, stress distribution, and consistent appearance when installed.

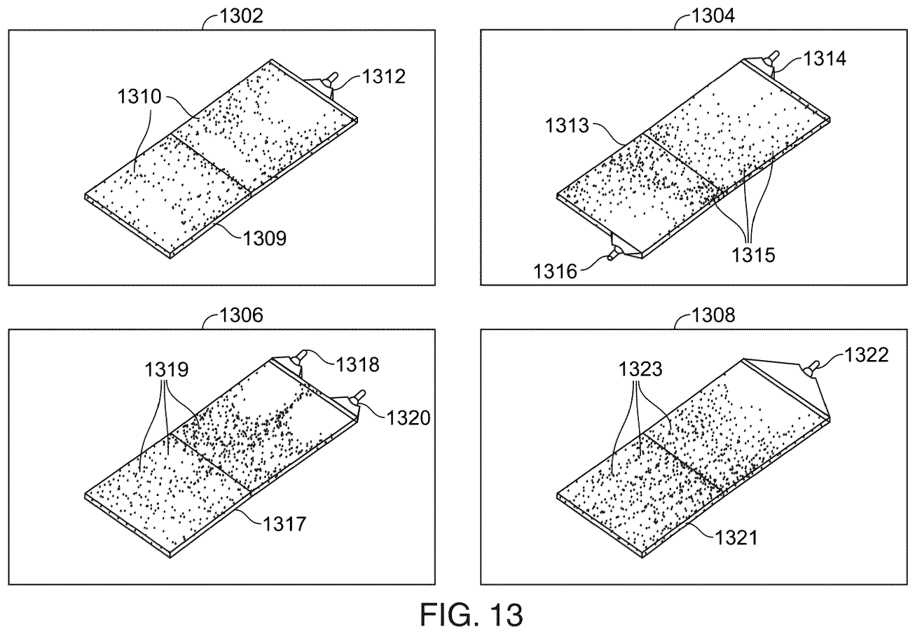

FIG. 13 illustrates four views 1302, 1304, 1306, and 1308 of various injection-molding gate positions and shows how particles flow through an illustrative tile in accordance with the principles of the disclosure. The depicted configurations demonstrate how gate positions can influence the local and global distribution of selected particles within the molded part.

Views 1302, 1304, 1306, and 1308, and associated injection-molding gate positions, are exemplary. Other, different, configurations of injection-molding gate positions are also within the scope of this disclosure. In particular:

View 1302 shows a portion of an illustrative tile 1309 with a single injection-molding gate 1312. Throughout the portion of illustrative tile 1309, a distribution of selected particles 1310 is shown.

View 1304 shows a portion of an illustrative tile 1313 with dual injection-molding gates 1314 and 1316. Throughout the portion of illustrative tile 1313, a distribution of selected particles 1315 is shown.

View 1306 shows a portion of an illustrative tile 1317 with same-tile-side dual injection-molding gates 1318 and 1320. Throughout the portion of illustrative tile 1317, a distribution of selected particles 1319 is shown.

View 1308 shows a portion of an illustrative tile 1321 with an enlarged injection-molding gate 1322. Throughout the portion of illustrative tile 1321, a distribution of selected particles 1323 is shown.

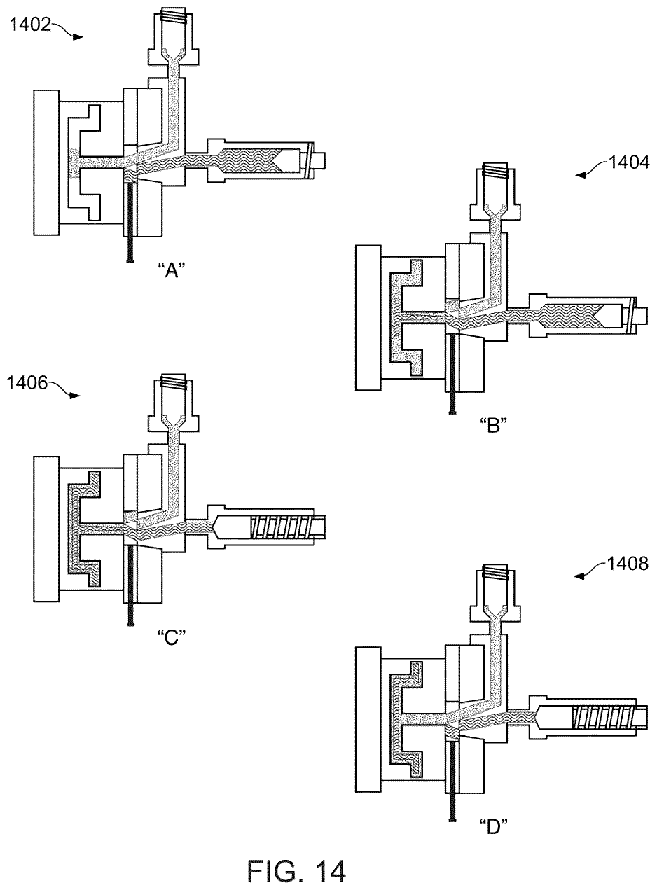

FIG. 14 illustrates a conventional co-injection process suitable for manufacturing roofing tiles. The sequence includes stages labeled A-D, with 1402 indicating stage A (material 1 partially fills the cavity), 1404 indicating stage B (material 2 begins to fill the cavity flowing between the outer laminates of material 1), 1406 indicating stage C (material 2 finishes filling the cavity), and 1408 indicating stage D (material 1 is re-introduced to finish packing and cover the gate region). The illustrated steps are exemplary and compatible with different material systems.

FIG. 15 shows a perspective view of another illustrative tile embodiment 1500. The area outside trapezoidal indentations is identified at 1502. A reinforcement bar 1501 (or, alternatively, plate) is shown running across the face of the conceal. The inside of a trapezoidal indentation is identified at 1508.

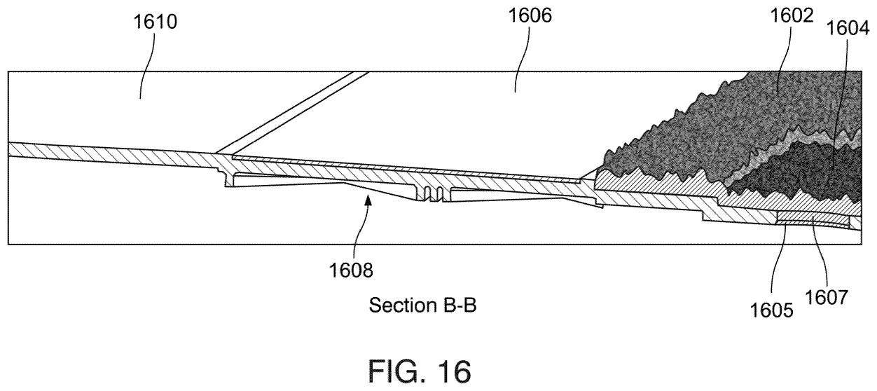

Section line B-B denotes a cross-section of the tile through a trapezoidal indentation that is shown in FIG. 16.

Dimensional indicators H1 (height of the tile), T1 (thickness of the tile), and L1 (length of the tile) are used where labeled (with H, T, and L denoting height, thickness, and length, respectively). Nail markings are shown on the reinforcement bar 1501.

FIG. 16 shows Section B-B, a cross-section taken through the tile as indicated in FIG. 15. The outside-of-trapezoidal region is identified at 1602. The inside-of-trapezoid region is identified at 1604. A reinforcement bar is identified at 1606. The back side of the tile showing a lattice-like pattern formed on the underside of the substrate is identified at 1608. The conceal region is identified at 1610. This cross-section illustrates how the reinforcement bar 1606 interacts with front-side features and tile underside 1608 lattice-like pattern, to provide stiffness. It should be noted that 1602 and 1604 may form parts of an over-molding, as described in more detail above.

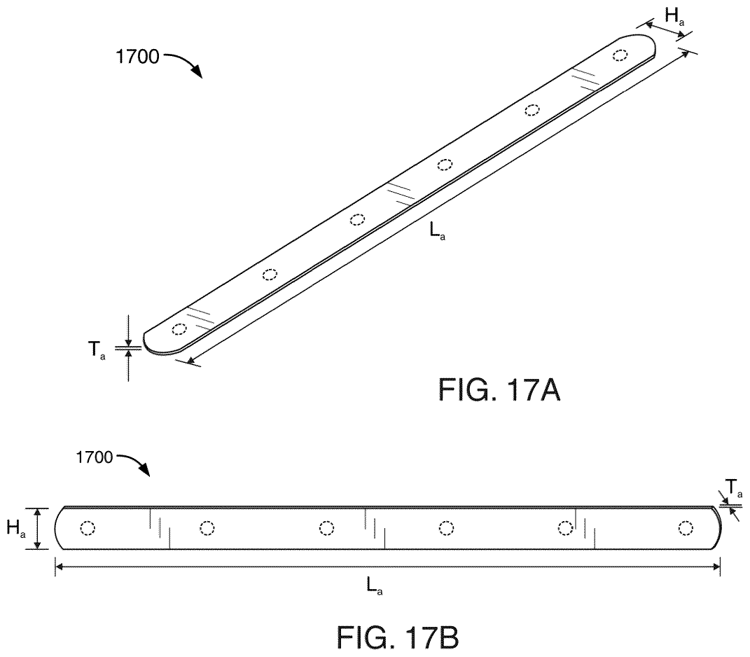

FIG. 17A shows a perspective view 1700 of a reinforcement bar. Dimensional indicators for the bar include La (length of the bar), Ha (height of the bar), and Ta (thickness of the bar). In all cases, L denotes length, T denotes thickness, and H denotes height. The plan presentation highlights the bar's footprint, edge transitions, and integration points with surrounding tile features. Nail markings are shown at 1702.

FIG. 17B shows a top-down view 1700 of the reinforcement bar corresponding to FIG. 17A. Dimensional indicators La (length of the bar), Ta (thickness of the bar), and Wa (width of the bar) are used to depict the bar's profile and thickness distribution along its span, illustrating how the bar contributes to stiffness without excessive weight. Nail markings are shown at 1702.

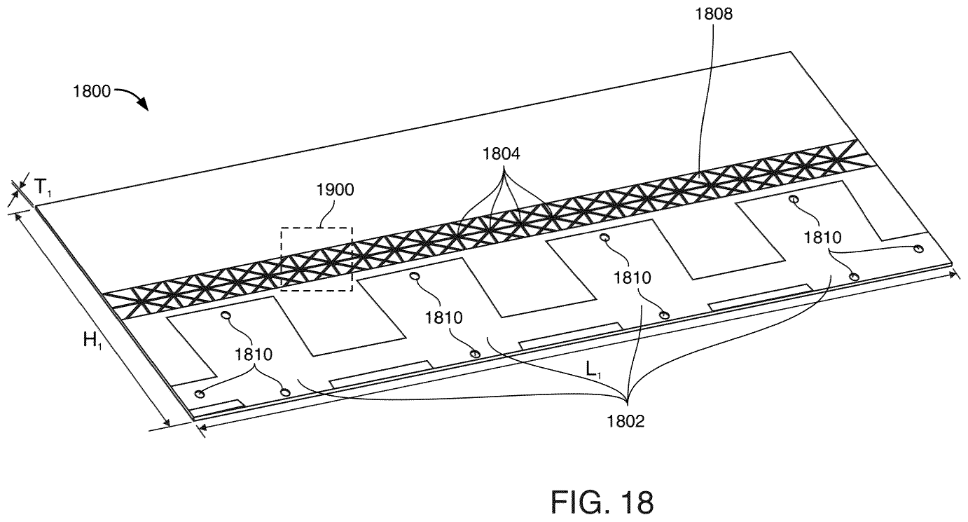

FIG. 18 shows a perspective view of an illustrative tile in accordance with the principles of the disclosure. A lattice-like pattern of material on the underside of the portion of the conceal supports reinforcement bar and is identified at 1804. The area in-between the patterned elements is identified at 1808.

Bosses 1810 distributed throughout the trapezoidal regions of the tile shown in FIG. 18 preferably enable the hot molten polymer of an overmold to be affixed in a more permanent fashion to the underlying portion of the tile. A boss according to the embodiments is partially shown in FIG. 16, at boss 1605. Boss 1605 preferably fills recess 1607 during the injection molding process. Thereafter, the fit of boss 1605 to recess 1607 preferably causes a greater fixity to recess through chemical bonding and physical attachment.

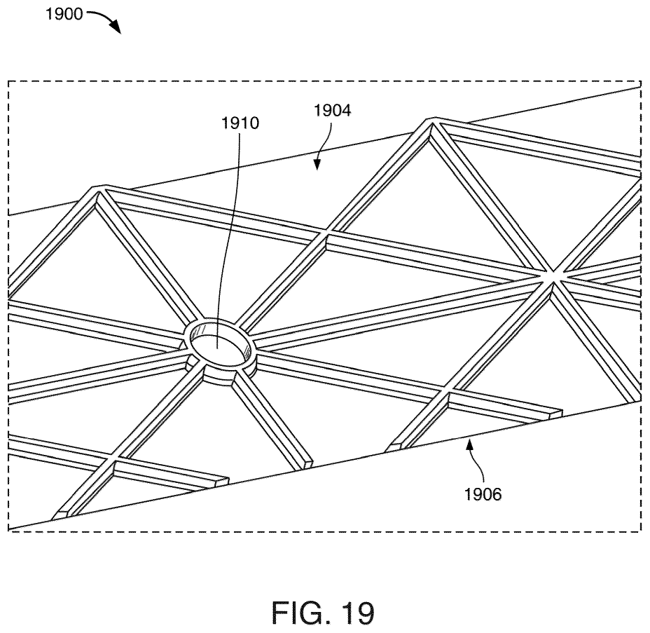

Overall dimensional indicators W1 (width of the tile), T1 (thickness of the tile), and L1 (length of the tile) are provided where labeled. Region 1900 designates a zoomed-in area that is shown in FIG. 19 to detail the lattice-like pattern 1804 and the interstitial regions 1808.

FIG. 19 shows a zoomed-in figure 1900 of the lattice-like pattern below the reinforcement bar within the conceal region. It should be noted that the lattice-like pattern may form the underside of a solid portion of a conceal (see FIG. 6, element 1608). A hole within the lattice-like pattern is identified at 1902, while triangular shapes outside the lattice-like pattern are identified at 1904 and 1906. This view highlights local pattern geometry, openings, and adjacent shapes that collectively influence stiffness, material flow during molding, and compatibility with fasteners or accessories.

The following table provides exemplary ranges for exemplary thicknesses of the parts of an illustrative roof shingle:

| Selected Dimension | Exemplary Ranges of Height |
|---|---|
| A-Substrate for | 1.0 mm to about 3.0 mm |
| step-top | |
| B-Substrate for | 0.5 mm to about 2.0 mm |
| step-bottom | |
| C-Surface texture | Between 0.0 mm and about 4.5 mm |
| for step-top, as | |
| measured from the | |
| top surface of the | |
| substrate for | |
| step-top | |
| D-Surface texture | Between 0.0 mm to about 3.5 mm |
| for step-bottom, as | |
| measured from the | |
| top surface of the | |
| substrate for | |
| step-bottom | |
| E-Surface | For the purpose of this application, surface |
| roughness-“Ra” | roughness (“Ra”) should be understood to |
| | be an average deviation of the granule size |
| | from a midpoint granule size. Thus, for the |
| | step-top texture, the midpoint granule size |
| | will preferably be 1.75 mm, and a |
| | determination, for a given number of |
| | granules per square unit area, will be the |
| | average deviation of the granules from the |
| | 1.75 mm. Such an average deviation may |
| | preferably depend, at least partially, on the |
| | characteristics of the random-number |
| | algorithm used to generate the granules. |
| | For the step-bottom texture, the midpoint |
| | granule size will preferably be 1.25 mm, |
| | and a determination, for a given number of |
| | granules per square unit area, will be the |
| | average deviation of the granules from the |
| | 1.25 mm. Such an average deviation may |
| | preferably depend, at least partially, on the |
| | characteristics of the random-number |
| | algorithm used to generate the granules. |

The following paragraphs correspond, with some added detail, to the table set forth hereinabove.

As set forth above, a preferred thickness for substrate A for a step-top portion of a reveal is between 1.0 mm and 3.0 mm. A most preferred thickness is about 2.0 mm.

A preferred thickness for substrate B for a step-bottom portion of a reveal is between 0.5 mm and 2.0 mm. A most preferred thickness is about 1.0 mm.

A preferred range of thickness for a surface texture C for the step-top portion of the reveal is between 0.0 mm and 4.5 mm.

A most preferred range of thickness of the surface texture C for the step-top portion of the reveal is between about 0.0 mm and 3.5 mm.

A preferred range of thickness for the surface texture C for the step-top portion of the reveal is between 0.0 mm and 4.5 mm. A most preferred range of thickness of the surface texture C for the step-top portion of the reveal is between about 0.0 mm and 3.5 mm.

A preferred range of thickness for the surface texture D for the step-bottom portion of the reveal is between 0.0 mm and 3.5 mm. A most preferred range of thickness of the surface texture D for the step-bottom portion of the reveal is between about 0.0 mm and 2.5 mm.

The present disclosure relates to a roofing tile or shingle featuring a unique surface texture and relief, achieved through the use of granules of varying sizes and a preferably multi-tiered substrate.

The disclosure further encompasses methods of manufacturing such tiles, including the use of one or more molding techniques to combine different materials for enhanced performance, resource conservation and aesthetic effects. The disclosure also defines parameters for surface texture, granule size, and material selection, and describes various manufacturing processes for creating the desired surface geometry and texture.

In some embodiments, the roofing tile or shingle may include a reveal area with a step-top layer presenting granules, or other particles or particle-type projections, between 0.0 mm and approximately 3.5 mm in size. Another area, which typically also forms part of the reveal, which may be contained within a trapezoidal region, may feature a lower layer with granules of approximately 2.5 mm in size that sits on a lower substrate to form a deeper relief (height from the bottom of the tile to the top of each substrate. Specifically, the difference in relief between the base of the 3.5 mm granule-size layer and the base of the 2.5 mm granule-size layer may be achieved by providing a substrate layer that is higher beneath the 3.5 mm granule-size layer and lower thickness beneath the 2.5 mm granule-size layer.

This variation in relief preferably creates a shadow line that is observable from a common viewing distance, such as street level, thereby enhancing the visual depth and dimensionality of the tile.

For the purposes of this application, the term “granule(s)” and/or “granule-size” should be understood to refer to any shape or feature that may project outwardly from the substrate of the reveal portion of the tile.

In certain embodiments, the total depth of the tile portion may preferably have a maximum height of about 6 mm measuring from the bottom, uniform, surface of the substrate to the top of the step-top portion of the reveal.

The step-top portion may have a random depth ranging from about 0 mm to about 3.5 mm, exclusive of the substrate, while the step-bottom portion may have a random depth ranging from about 0 mm to about 2.5 mm, exclusive of the substrate.

These random depths, obtained through varying granule sizes, can be generated using, e.g., a random-number generating algorithm. Generating granules using the random-number generating algorithm may preferably obtain a unique and non-repetitive surface texture.

To reiterate, the substrate underlying the entire reveal may vary between a depth of about 1.0 mm to a depth of about 2.0 mm, e.g., a variance of approximately 1.5875 mm ( 1/16 inch). Also as mentioned above, the minimum 1.0 mm depth may facilitate the flow of tile material throughout the mold during manufacturing, thereby ensuring complete and consistent formation of the tile's features.

The material for the tile may be selected from a group including, but not limited to, thermoplastic vulcanizate (TPV), ethylene propylene diene monomer (EPDM), thermoplastic polyolefin (TPO), thermoplastic elastomer (TPE), polypropylene (PP), glass-filled polypropylene (PP GF, with glass fill ranging from 0% to 50%), high-density polyethylene (HDPE), glass-filled HDPE (HDPE GF), and polyvinyl chloride (PVC), or any other suitable material or combination of materials.

Different grades of these materials may be used for the base and the over-mold, respectively, to achieve desired properties such as fire resistance and mechanical performance (described in more detail herein). When the disclosure employs an over-mold design, a first material is used for the base layer—e.g., the substrate, and a different material is be used for the top layer—e.g., the textured portion of the reveal. The over-molded material may be used to provide improved performance characteristics. Such performance characteristics may include providing different coloring, speckling effects, and/or enhanced flame retardancy.

Over-molding is accomplished, in an exemplary embodiment, by first injection-molding the base part, then placing it in an empty mold cavity, closing the mold, and injection molding the second material over it. The two materials bond mechanically or chemically, thereby obtaining, after cooling and ejection from the mold, a single, integrated part.

Granule or particle size parameters for the color particles may range from about 0.2 mm to about 0.9 mm. The surface roughness of the reveal may be defined as an average distance from a midline measurement of granules. In the present application, a preferred roughness measurement for the step-top is between 0.0 and about 1.75 mm while a preferred roughness measurement for the step-down in between 0.0 and 1.25 mm.

Additional parameters for describing the pattern may include the number of peaks per square inch and the Ra (surface roughness) value, which captures the form features and maximum heights of the granules.

The method of manufacturing the mold for the tile may include various processes such as, by one or more of the following list of non-limiting examples: electrical discharge machining (EDM), laser machining, conventional machine tooling, or chemical etching. These processes are used to impart the desired texture and geometry to the mold, which is then used to form the roofing tile or shingle. The disclosure may also employ a topographical mapping technique, wherein a grey level speckle map is generated by a computer to assign random heights to the granules on the surface, resulting in a unique and visually appealing texture.

The disclosure further includes the ability to measure and define the texture using parameters such as maximum height, surface roughness (Ra), root mean square (RMS) values, and standard deviation of the surface roughness. The separation of material selection from geometry allows for broad applicability across different molding processes. Exemplary molding processes may include injection-molding and/or compression molding. Furthermore, tiles in accordance with the principles of the disclosure may preferably be used with one or more of a wide range of materials suitable for the roofing industry.

In certain embodiments, a roofing tile is provided with a unique multi-level surface texture designed to enhance both the aesthetic and functional properties of the tile. The total depth of the textured portion of the tile may be up to about 6 mm. The surface texture is characterized by a step-top region and a step-bottom region, each having a random depth profile. The step-top texture may have a random depth ranging from about 0 mm to about 3.5 mm, while the step-bottom texture may have a random depth ranging from about 0 mm to about 2.5 mm. The randomness of these depths can be generated using a pre-determined random-number generating algorithm, which ensures a non-repetitive, natural appearance and can also contribute to improved light scattering and shadow effects, thereby enhancing the visual depth and realism of the tile when installed on a roof.

As mentioned, the material composition of the tile is not limited to a single polymer but may be selected from a group comprising thermoplastic vulcanizate (TPV), ethylene-propylene-diene terpolymer (EPDM), thermoplastic polyolefin (TPO), thermoplastic elastomer (TPE), polypropylene (PP), glass-filled polypropylene (PP GF, with glass fill ranging from 0% to 50%), high-density polyethylene (HDPE), glass-filled high-density polyethylene (HDPE GF), and polyvinyl chloride (PVC). This broad selection of materials allows for optimization of the tile's properties, such as flexibility, durability, fire resistance, and cost-effectiveness, depending on the specific application and performance requirements.

In some embodiments, one area in the reveal may present, and include, a 3.5 mm granule size on its top layer. In such embodiments another area (shown in FIG. 6 contained within the trapezoids), may present, and include a 2.5 mm granule-size on a lower layer.

The difference in the relief of the base of the 3.5 mm granule-size layer and the relief of the base of the 2.5 mm granule-size layer may be obtained by providing a substrate layer that presents higher under the 3.5 mm granule-size layer and presents lower under the 2. 5 mm granule-size layer. The difference in the relief of the reveal may obtain an appearance that casts a shadow line. The shadow line is preferably observable by an observer viewing the roof from a common distance, such as street level. It should be noted that, for the purposes of this application, a granule-size may denote any shape that projects outwardly from the baseline of the reveal of the tile.

In some embodiments, the total depth of the portion of the tile shown may have a maximum of 6 mm. The step-top texture may have a random depth of between about 0.0 mm and about 3.5 mm and the step-bottom texture may have a random depth of between about 0 mm and about 2.5 mm. Such a random depth may be generated by a preferably pre-selected, random-number generating, algorithm.

The substrate underlying the reveal may have an exemplary minimum depth of about 1.0 mm, or 1/16 of an inch. Such a minimum depth may enable the tile material to flow throughout the mold.

A grey level speckle map, according to some embodiments, is generated where black corresponds to a value of 0 (RGB: 0,0,0) and white corresponds to a value of 255 (RGB: 255,255,255). The resulting image resembles static on a television screen, with an even distribution of grey values, potentially following a Gaussian distribution.

In this system, the computer interprets the grey values as corresponding to physical heights, with white representing the maximum height (over substrate) of 3.5 mm. Darker areas indicate lower points, while lighter areas indicate higher points. Such a grey level speckle map system may preferably be used to create a mold that could be used to form a discrete, preferably pre-determined, area of the textured surfaces of the reveal.

This mapping technique allows for the creation of a topographical map, which can be applied to the surface of a shingle. The process results in a unique texture, and while similar methods have been used by engineers in other fields, this approach has not previously been applied to roofing materials.

The methods disclosed herein involve processes for generating the texture of a three-dimensional system. This includes the ability to measure surface profiles, determine maximum heights, and calculate the root mean square (RMS) value for surface roughness (Ra).

Several techniques can be used to create or measure these textures, including: 1) Electrical Discharge Machining (EDM); 2) laser processing; 3) machine tooling; and/or 4) chemical etching. Each of these methods preferably offers a different approach to generating or analyzing the textured surface, contributing to the overall innovations in roofing tile design.

The embodiments of roofing tiles described herein feature a textured surface designed to enhance both functional and aesthetic properties. The surface texture has a total depth, in some locations, up to about 6 mm. The surface of the reveal of the roofing tiles may be divided into two distinct regions: a step-top texture region with a random depth ranging from approximately 0 mm to about 3.5 mm, and a step-bottom texture region with a random depth ranging from approximately 0 mm to about 2.5 mm. In certain embodiments, the random depths of either or both of the step-top and step-bottom texture regions may be between about 0.0 mm and about 4.5 mm. The random depths of granules, particles and/or projections in these regions are generated by a preferably pre-determined random-number generating algorithm. Such random definition of depths preferably ensures a non-repetitive, naturalistic appearance across the tile.

Beneath the reveal portion of the tile, a substrate is provided with a thickness of about 1.0 mm under a first portion of the reveal and a thickness of about 2.0 mm under a second, different, portion of the reveal. Such thickness, which are both greater than 1.0 mm, are preferably configured to facilitate optimal material flow during the manufacturing process.

The substrate under the step-bottom textured region may most preferably be about 1.0 mm while the substrate under the step-top texture region may most preferably be about 2.0 mm.

The random-number generating algorithm is specifically configured to produce a surface texture that mimics the irregularity found in tiles formed from natural materials, thereby enhancing the visual depth and shadow effects of the installed tile. The textured surface may be formed by various manufacturing techniques, such as molding, injection molding, compression molding, or calendering, and may include a plurality of granules within the specified depth ranges. The substrate underlying the reveal is continuous and uniform in thickness, and the relief pattern of the textured surface is designed to be observable as a shadow line from a threshold distance from the tile, such as from street level. The threshold distance from the tile may be, e.g., 1 m-100 m from the tile.

A method of producing the roofing tile involves molding a selected polymeric material above and below a reinforcement core (or, in the alternative, a reinforcement plate or bar), which may be composed of galvanized steel, steel, or a glass-filled polymer. The reinforcement core is embedded within the polymeric material, which comprises an outward-facing surface and a substrate-facing surface. The outward-facing surface includes a reveal and a conceal, with the reveal being visible when the tile is installed and the conceal being covered by an upslope adjacent tile. The method includes generating a textured surface on at least a portion of the reveal by forming step-top and step-bottom texture regions of different relief, with the difference in relief creating a visible shadow line. An adhesive sealant may be applied to the substrate-facing surface to bind the tile to a downslope adjacent tile or to a substrate.

The step-top and step-bottom texture regions may each be generated to have a random depth in the range of about 1.5 mm to about 4.5 mm. The textured surface may further include a plurality of granules sized between about 0.5 mm and about 2.5 mm, molded to at least a portion of the reveal. The step of generating the textured surface may utilize a computer-generated topographical map, assigning random heights to the surface based on a gray level speckle map, where black corresponds to 0 mm and white corresponds to 3.5 mm. The molding process may also include over-molding a different material, or a different grade or mixture of the same material, onto the reveal portion to provide improved fire resistance, color variation, or surface speckling.

The reinforcement core may have a thickness of about 0.01 inch to about 0.05 inch and may extend about 35 to 40 inches along the horizontal length of the tile. The method may further include forming geometric tabs on the reveal, with each tab being about 4 to 5 inches in horizontal length and configured to alternate with tabs of adjacent tiles.

In summary, the disclosure provides a roofing tile or shingle with a novel surface texture and relief, methods for manufacturing such tiles using molding and advanced mold-making techniques, and a comprehensive set of parameters for defining and measuring the surface texture. The combination of these features results in a product with enhanced aesthetic, functional, and economic benefits.

Variations of up to about +10% of values, dimensions or ranges presented herein are within the scope of the disclosure.

Thus, polymeric roof shingles with certain geometries and methods of production thereof are provided. Persons skilled in the art may appreciate that the present invention can be practiced by other than the described embodiments, which are presented for purposes of illustration rather than of limitation. The present invention is limited only by the claims that follow.

What is claimed is:

1. A roofing tile comprising a reveal and a conceal, the reveal comprising:
a textured surface having a total depth of up to about 6 millimeters (“mm”), said textured surface comprising:
a step-top texture region with a random depth between about 0 mm and about 3.5 mm;
a step-bottom texture region with a random depth between about 0 mm and about 2.5 mm; and
a substrate underlying the textured surface, said substrate comprising:
a region underlying the step-top texture region; and
a region underlying the step-bottom region;
wherein:
the region underlying the step-top texture region is about 2.0 mm; and
the region underlying the step-bottom region is 1.0 mm or greater than 1.0 mm.

2. The roofing tile of claim 1, wherein the random depth of the step-top texture region and the random depth of the step-bottom texture region are generated by a selected random-number generating algorithm.

3. The roofing tile of claim 1, wherein a material of the tile is selected from the group consisting of thermoplastic vulcanizate (TPV), ethylene-propylene-diene terpolymer (EPDM), thermoplastic polyolefin (TPO), thermoplastic elastomer (TPE), polypropylene (PP), glass-filled polypropylene (PP GF, 0-50% glass fill), high-density polyethylene (HDPE), glass-filled high-density polyethylene (HDPE GF), and polyvinyl chloride (PVC).

4. The roofing tile of claim 1, wherein a random-number generating algorithm is configured to produce a non-repetitive, naturalistic surface texture across the step-top texture region and the step-bottom texture region.

5. The roofing tile of claim 1, wherein the substrate underlying the reveal of the tile has a depth of about 1.0 mm.

6. The roofing tile of claim 1, wherein the textured surface is configured to enhance light scattering and shadow effects for improved visual depth of the tile.

7. The roofing tile of claim 1, wherein the step-top and step-bottom texture regions are formed by molding.

8. The roofing tile of claim 1, wherein the random depth of the step-top texture region is generated independently of the random depth of the step-bottom texture region.

9. The roofing tile of claim 1, wherein the textured surface comprises a plurality of granules having heights within about 0.5 mm and about 2.5 mm.

10. The roofing tile of claim 1, wherein the substrate underlying the reveal is continuous.

11. The roofing tile of claim 1, wherein the textured surface comprises a relief pattern that is observable as a shadow line from a threshold distance away from the tile.

12. A method of manufacturing a roofing tile, the method comprising:
manufacturing a reinforcement core;
molding a selected polymeric material, said molded material having a cavity formed therewithin, said cavity for receiving fixed placement of the reinforcement core, the polymeric material comprising a reveal and a conceal, the reveal being visible when the roofing tile is installed and the conceal being covered by an upslope adjacent roofing tile when the roofing tile is installed; and
forming, on the reveal, an upward facing surface comprising:
a step-top texture region; and
a step-bottom texture region, wherein:
a relief between the step-top texture region and the step-bottom texture region creates a visible shadow line between the step-top texture region and the step-bottom texture region;
the step-top texture region comprises a top surface with first random-depth granules and the step-bottom texture region comprises a top surface with second random-depth granules, and
the relief is formed from, at least in part, a difference in substrate thickness between a substrate thickness under the step-top texture region and a substrate height under the step-bottom texture region, wherein the difference is not less than 1.0 mm.

13. The method of claim 12 further comprising applying an adhesive sealant to a downward-facing surface of the conceal, said adhesive sealant for binding the substrate under the step-top texture region and the substrate under the step-bottom texture region to a downslope adjacent roofing tile.

14. The method of claim 12, wherein the reinforcement core comprises at least one of galvanized steel, steel, and a glass-filled polymer.

15. The method of claim 12, wherein the step-top texture region comprises a random depth between about 1.5 mm to about 4.5 mm, and the step-bottom texture region is generated to have a random depth between about 1.5 mm to about 4.5 mm.

16. The method of claim 12, wherein the step-bottom texture region further comprises a plurality of granules having sizes between about 0.5 mm and about 2.5 mm, the granules being molded to form at least a portion of the reveal.

17. The method of claim 12, wherein a surface roughness (Ra) value for the step-bottom texture region is in the range of about 0.0 mm to 1.25 mm and an Ra value for the step-top texture region is in the range of about 0.0 mm and about 1.75 mm for the step-top surface region.

18. The method of claim 12, wherein the forming the step-bottom texture region comprises using a computer-generated topographical map to assign random heights to the surface based on a gray level speckle map, with black corresponding to 0.0 mm and white corresponding to 3.5 mm.

19. The method of claim 12, wherein the molding comprises over-molding an over-molding material onto the reveal, said over-molding material being different from a material from which the reveal is formed.

20. The method of claim 12, wherein the reinforcement core is about 0.01 inch to about 0.05 inch thick and extends about 35 to 40 inches along a horizontal length of the roofing tile.

21. The method of claim 12, further comprising forming geometric tabs on the reveal, the geometric tabs being between about 4.0 inches to 5.0 inches along a horizontal length of the roofing tile and configured to alternate with tabs of adjacent roofing tiles.

22. The method of claim 12, wherein the selected polymeric material is chosen from the group consisting of thermoplastic vulcanizate (TPV), ethylene propylene diene monomer (EPDM), thermoplastic polyolefin (TPO), thermoplastic elastomer (TPE), polypropylene (PP), glass-filled polypropylene (PP GF, with glass fill ranging from 0% to 50%), high-density polyethylene (HDPE), glass-filled HDPE (HDPE GF), and polyvinyl chloride (PVC).

23. The method of claim 12, wherein the fixed placement of the reinforcement core in the cavity is obtained by affixing the reinforcement core in the cavity using a permanent adhesive.

24. The method of claim 12, wherein the cavity formed in the conceal.
